(19) United States
(12) Patent Application Publication
(10) Pub. No.: US 2016/0338128 A1
(43) Pub. Date: Nov. 17, 2016

(54) Reporting of Terminal Connection Status

(71) Applicant: TELEFONAKTIEBOLAGET LM ERICSSON (PUBL), Stockholm (SE)

(72) Inventors: Icaro L.J. da Silva, Bromma (SE); Mattias Tan Bergström, Stockholm (SE)

(73) Assignee: TELEFONAKTIEBOLAGET LM ERICSSON (PUBL), Stockholm (SE)

(21) Appl. No.: 14/906,326

(22) PCT Filed: Dec. 21, 2015
(86) PCT No.: PCT/SE2015/051381

§ 371 Date: Jan. 20, 2016

Related U.S. Application Data
(60) Provisional application No. 62/101,570, filed on Jan. 9, 2015.

(51) Int. Cl. H04W 76/02

(52) U.S. Cl. CPC H04W 76/025; H04W 84/045

(57) ABSTRACT

According to one embodiment, a cellular network node apparatus is adapted to send (1310), to a first node in a WLAN, a request for a subscription to connection status information for wireless terminals and subsequently receive (1320) a first report from the WLAN. The first report indicates that a first wireless terminal, covered by the subscription request, has connected to the WLAN. The cellular network node apparatus is also adapted to determine (1330), based on the first report, to hold context information for the first wireless terminal, rather than releasing the context information.

### TECHNICAL FIELD

The technology disclosed herein relates generally to wireless communication networks, and more particularly relates to techniques for sharing information between wireless local-area networks and cellular networks, to improve traffic offloading.

### BACKGROUND

The Evolved UMTS Terrestrial Radio Access Network (E-UTRAN), standardized by members of the 3^{rd} Generation Partnership Project (3GPP), includes base stations called enhanced NodeBs (eNBs or eNodeBs), providing the E-UTRA user plane and control plane protocol terminations towards the UE (user equipment, 3GPP terminology for wireless devices that access the wireless network). The eNBs are interconnected with each other using the X2 interface. The eNBs are also connected using the S1 interface to the EPC (Evolved Packet Core), more specifically to the MME (Mobility Management Entity) by means of the S1-MME interface and to the Serving Gateway (S-GW) by means of the S1-U interface. The S1 interface supports many-to-many relation between MMEs/S-GWs and eNBs. A simplified view of the E-UTRAN architecture is illustrated in FIG. 1.

The eNB 210 hosts functionalities such as Radio Resource Management (RRM), radio bearer control, admission control, header compression of user plane data towards serving gateway, and/or routing of user plane data towards the serving gateway. The MME 220 is the control node that processes the signaling between the UE and the CN (core network). Significant functions of the MME 220 are related to connection management and bearer management, which are handled via Non Access Stratum (NAS) protocols. The S-GW 230 is the anchor point for UE mobility, and also includes other functionalities such as temporary DL (down link) data buffering while the UE is being paged, packet routing and forwarding to the right eNB, and/or gathering of information for charging and lawful interception. The PDN Gateway (P-GW, not shown in FIG. 1) is the node responsible for UE IP address allocation, as well as Quality of Service (QoS) enforcement (as further discussed below). The reader is referred to 3GPP TS 36.300 and the references therein for further details of functionalities of the different nodes.

FIG. 2 gives a summary of the functionalities of the different nodes, and the reader is referred to the 3GPP document “Evolved Universal Terrestrial Radio Access (E-UTRA) and Evolved Universal Terrestrial Radio Access Network (E-UTRAN); Overall Description; Stage 2,” 3GPP TS 36.300, v. 11.3.0 (September 2012), available at www.3gpp.org, and the references therein for the details of the functionalities of the different nodes. In FIG. 2, the boxes labeled “eNB,” “MME,” “S-GW,” and “P-GW” depict the logical nodes, the boxes within the larger boxes depict the functional entities of the control plane, and the boxes within the box labeled “eNB” also includes further boxes depicting the radio protocol layers.

The wireless local-area network (WLAN) technology known as “Wi-Fi” has been standardized by IEEE in the 802.11 series of specifications (i.e., as “IEEE Standard for Information technology-Telecommunications and information exchange between systems. Local and metropolitan area networks—Specific requirements. Part 11: Wireless LAN Medium Access Control (MAC) and Physical Layer (PHY) Specifications”).

Using Wi-Fi/WLAN (the two terms are used interchangeably throughout this document) to offload traffic from the mobile networks is becoming more and more interesting from both the operator's and end user's points of view. Reasons for this include the additional frequency that may be obtained: by using Wi-Fi, operators can access an additional 85 MHz of radio bandwidth in the 2.4 GHz band and another (close to) 500 MHz in the 5 GHz band. Cost is another factor Wi-Fi uses unlicensed frequency that is free of charge. On top of that, the cost of Wi-Fi Access Points (APs), from both capital expense (CAPEX) and operational expense (OPEX) perspectives, is considerably lower than that of a 3GPP base station (BS/eNB). Operators can also take advantage of already deployed APs that are already deployed in hotspots such as train stations, airports, stadiums, shopping malls, etc. Most end users are also currently accustomed to having Wi-Fi for free at home (as home broadband subscriptions are usually flat rate) and at many public places. Another factor is the high data rates that are increasingly demanded by customers. Under low interference conditions and assuming the user is close to the Wi-Fi AP, Wi-Fi can provide peak data rates that outshine that of current mobile networks (for example, theoretically up to 600 Mbps for IEEE 802.11n deployments with MIMO (Multiple Input Multiple Output)).

Still another factor in this increased interest in Wi-Fi integration or at least in closer cooperation between WLANs and cellular networks is the rapidly increasing support for Wi-Fi among cellular telephones, since many portable devices currently available in the market, including virtually all smartphones, support Wi-Fi. Note that in the specifications that define the Wi-Fi world, the term “Station” (STA) is used instead of UE; because this document is generally considered with devices that support both a cellular technology (such as E-UTRA) and Wi-Fi, the terms UE, STA and terminal are used interchangeably in this document.

A very simplified Wi-Fi architecture is illustrated in FIG. 3 and FIG. 4. On the user plane (FIG. 3), a very lean architecture is employed, where the UE/STA is connected to the Wi-Fi AP, which can be directly connected to the Internet. In the control plane (FIG. 4), an Access Point Controller (AC) may handle the management of the AP. One AC usually handles the management of several APs. Security/authentication of users can be handled via an Authentication, Authorization and Accounting (AAA) entity, which is shown as a RADIUS server in FIG. 4. Remote Administration Dial In User Service (RADIUS) is the most widely used network protocol for providing a centralized AAA management (RFC 2865).

The Access Network Discovery and Selection Function (ANDFS) is an entity defined by 3GPP for providing access discovery information as well as mobility and routing policies to the UE. ANDFS is a new entity added to the 3GPP architecture in Release 8 of 3GPP TS 23.402 (See “Architecture Enhancements for non-3GPP Accesses,” 3GPP TS 23.402, v. 11.4.0 (September 2012), available at www.3gpp.org). A simplified ANDSF architecture is depicted in FIG. 5. As shown in the figure, the ANDSF server is only connected to the UE, and its main goal is to provide the UE with access network information in a resource efficient and secure manner. The communication between the UE and the ANDSF server is defined as an IP-based S14-interface.

By supplying information about both available 3GPP and non-3GPP access networks to the UE, the ANDSF enables an energy-efficient mechanism of network discovery, where the UE can avoid continuous and energy-consuming background scanning. Furthermore, ANDSF provides the mobile operators with a tool for the implementation of flexible and efficient UE steering of access mechanisms, where policy control can guide UEs to select one particular radio access network (RAN) over another. Note that this may be an overstatement if ANDSF is implemented as an “app”, since it then relies on operating system (OS) support and prioritization of ANDSF in relation to other “apps”. This condition may be only partly fulfilled, which thus makes the control of the UE via the ANDSF somewhat unreliable.

The ANDSF supplies three types of information—discovery information, inter-system mobility policies (ISMP) and inter-system routing policies (ISRP). All these are summarized and implemented via ANDSF managed objects (MO), which are communicated to the UEs via an over-the-top (OTT) signaling channel, as SOAP-XML messages.

The discovery information provides the UE with information regarding the availability of different RATs in the UE's vicinity. This helps the UE to discover available (3GPP and) non-3GPP access networks without the burden of continuous background scanning. Inter-System Mobility Policies (ISMP) are policies which guide the UE to select the most preferable 3GPP or non-3GPP access. The ISMP are used for UEs that access a single access (3GPP or Wi-Fi) at a time. The ISMP information specifies the behavior of UEs that can be connected to only one access network at a given time (either 3GPP, WLAN, WiMAX, etc). If the UE, however, supports connection to several access networks at the same time, the operator can use the third type of information (ISRP) to increase the granularity of the RAN selection. In that case, the UEs will be provided with policies that specify how the traffic flows should be distributed over the different RANs. For example, voice might be only allowed to be carried over the 3GPP RAN, while Internet video streaming and best-effort traffic can be routed via WLAN. The ANDSF provides mobile operators with a tool to determine how the UEs connect to different RANs, and hence allows them to add more flexibility in their traffic planning.

3GPP is currently specifying mechanisms for access selection and/or traffic steering between 3GPP networks and WLAN. These mechanisms are described in the 3GPP document 3GPP TS 36.300 v12.2.0 (June 2014), which is available at http://www.3gpp.org. The following excerpt from 3GPP TS 36.300, reformatted with references removed, provides a simplified description of this mechanism.

### 23.6.1 General Principles

This version of the specification supports E-UTRAN assisted UE based bi-directional traffic steering between E-UTRAN and WLAN for UEs in RRC_IDLE and RRC_CONNECTED.

E-UTRAN provides assistance parameters via broadcast and dedicated RRC signalling to the UE. The RAN assistance parameters may include E-UTRAN signal strength and quality thresholds, WLAN channel utilization thresholds, WLAN backhaul data rate thresholds, WLAN signal strength and quality thresholds and Offload Preference Indicator (OPI). E-UTRAN can also provide a list of WLAN identifiers to the UE via broadcast signalling. WLANs provided by E-UTRAN may include an associated priority.

The UE uses the RAN assistance parameters in the evaluation of: Traffic steering rules defined in TS 36.304; or ANDSF policies defined in TS 24.312 for traffic steering decisions between E-UTRAN and WLAN as specified in TS 23.402. The OPI is only used in ANDSF policies as specified in TS 24.312. WLAN identifiers are only used in traffic steering rules defined in TS 36.304.

If the UE is provisioned with ANDSF policies it shall forward the received RAN assistance parameters to upper layers, otherwise it shall use them in the traffic steering rules defined in section 23.6.2 and TS 36.304. The traffic steering rules defined in section 23.6.2 and TS 36.304 are applied only to the WLANs of which identifiers are provided by the E-UTRAN.

The UE in RRC_CONNECTED shall apply the parameters obtained via dedicated signalling if such have been received from the serving cell; otherwise, the UE shall apply the parameters obtained via broadcast signalling.

The UE in RRC_IDLE shall keep and apply the parameters obtained via dedicated signalling, until cell reselection or a timer has expired since the UE entered RRC_IDLE upon which the UE shall apply the parameters obtained via broadcast signalling.

In the case of RAN sharing, each PLMN sharing the RAN can provide independent sets of RAN assistance parameters.

### 23.6.2 Access Network Selection and Traffic Steering Rules

The UE indicates to upper layers when (and for which WLAN identifiers along with associated priorities, if any) access network selection and traffic steering rules defined in TS 36.304 are fulfilled. The selection among WLAN APs that fulfill the access network selection and traffic steering rules is up to UE implementation.

When the UE applies the access network selection and traffic steering rules defined in TS 36.304, it performs traffic steering between E-UTRAN WLAN with APN granularity. User preference takes precedence (FFS whether it does not apply to particular scenarios).

Below is a more detailed description of the access network selection and traffic steering rules. This is a reformatted version of what can be found in 3GPP TS 36.304, v12.3.0 (January 2015).

### 5.6 RAN-Assisted WLAN Interworking

The purpose of this procedure is to facilitate RAN-assisted WLAN interworking.

### 5.6.1 RAN Assistance Parameter Handling in RRC_IDLE

RAN assistance parameters may be provided to the UE in SystemInformationBlockType17 or in the RRCConnectionReconfiguration message. RAN assistance parameters are used only if the UE is camped normally.

Upon T350 expiry or upon selection/reselection of a cell which was not the PCell when RAN assistance parameters were received in the RRCConnectionReconfiguration message, the UE shall discard the RAN assistance parameters received in the RRCConnectionReconfiguration message and apply the RAN assistance parameters received in SystemInformationBlockType17. Note that in RRC_CONNECTED, upon cell selection initiated by RRC connection re-establishment, the UE does not discard RAN assistance parameters received in the RRCConnectionReconfiguration message.

The upper layers in the UE shall be notified (see TS 24.302) whenever changes in the current RAN assistance parameters occur, if upper layers require so.

### 5.6.2 Access Network Selection and Traffic Steering Rules

The rules in this sub-clause are only applicable for WLAN for which an identifier has been signaled to the UE by E-UTRAN and the UE is capable of access network selection and traffic steering rules. Coexistence with ANDSF based WLAN selection and traffic steering methods on the UE is based on mechanism described in TS 23.402. The rules refer to the following quantities:

TABLE 1

| | |
|---|---|
| ChannelUtilizationWLAN | WLAN channel utilization as defined in |
| | subclause 8.4.2.30. |
| BackhaulRateDlWLAN | WLAN DLBandwidth as defined in |
| | subclause 9.1.2. |
| BackhaulRateUlWLAN | WLAN ULBandwidth as defined in |
| | subclause 9.1.2. |
| BeaconRSSI | WLAN Beacon RSSI. |
| RSRPmeas | Qrxlevmeas in RRC_IDLE, and PCell |
| | RSRP in RRC_CONNECTED as defined in |
| | TS 36.331. |
| RSRQmeas | Qqualmeas in RRC_IDLE, and PCell |
| | RSRQ in RRC_CONNECTED as defined |
| | in TS 36.331. |

The upper layers in the UE shall be notified (see TS 24.302) when and for which WLAN identifiers (part of the list in subclause 5.6.3) the following conditions 1 and 2 for steering traffic from E-UTRAN to WLAN are satisfied for a time interval Tsteering_{WLAN}:

1. In the E-UTRAN serving cell:
RSRPmeas<Thresh_{ServingOffloadWLAN, LowP}; or
RSRQmeas<Thresh_{ServingOffloadWLAN, LowQ}.

2. In the target WLAN:
ChannelUtilization WLAN<Thresh_{ChUtilWLAN, Low}; and
BackhaulRateDlWLAN>Thresh_{BackhRateDLWLAN, High}; and
BackhaulRateUlWLAN>Thresh_{BackhRateULWLAN, High}; and
BeaconRSSI>Thresh_{BeaconRSSIWLAN, High}.

The UE shall not consider the metrics for which a threshold has not been provided. The UE shall evaluate the E-UTRAN conditions on PCell only. If not all metrics related to the provided thresholds can be acquired for a WLAN BSS, the UE shall exclude that WLAN BSS from the evaluation of the above rule.

The upper layers in the UE shall be notified (see TS 24.302) when the following conditions 3 or 4 for steering traffic from WLAN to E-UTRAN are satisfied for a time interval Tsteering_{WLAN}:

3. In the source WLAN:
ChannelUtilizationWLAN>Thresh_{ChUtilWLAN, High}; or
BackhaulRateDlWLAN<Thresh_{BackhRateDLWLAN, Low}; or
BackhaulRateUlWLAN<Thresh_{BackhRateULWLAN, Low}; or
BeaconRSSI<Thresh_{BeaconRSSIWLAN, Low}.

4. In the target E-UTRAN cell:
RSRPmeas>Thresh_{ServingOffloadWLAN, HighP}; and
RSRQmeas>Thresh_{ServingOffloadWLAN, HighQ}.
   The UE shall not consider the metrics for which a threshold has not been provided. The UE shall evaluate the E-UTRAN conditions on PCell only.

### 5.6.3 RAN Assistance Parameters Definition

The following RAN assistance parameters for RAN-assisted WLAN interworking may be provided:

Thresh_{ServingOffloadWLAN, LowP}
This specifies the RSRP threshold (in dBm) used by the UE for traffic steering to from E-UTRAN to WLAN.

Thresh_{ServingOffloadWLAN, HighP}
This specifies the RSRP threshold (in dBm) used by the UE for traffic steering from WLAN to E-UTRAN.

Thresh_{ServingOffloadWLAN, LowQ}
This specifies the RSRQ threshold (in dB) used by the UE for traffic steering from E-UTRAN to WLAN.

Thresh_{ServingOffloadWLAN, HighQ}
This specifies the RSRQ threshold (in dB) used by the UE for traffic steering from WLAN to E-UTRAN.

Thresh_{ChUtilWLAN, Low}
This specifies the WLAN channel utilization (BSS load) threshold used by the UE for traffic steering from E-UTRAN to WLAN.

Thresh_{ChUtilWLAN, High}
This specifies the WLAN channel utilization (BSS load) threshold used by the UE for traffic steering from WLAN to E-UTRAN.

Thresh_{BackhRateDLWLAN, Low}
This specifies the backhaul available downlink bandwidth threshold used by the UE for traffic steering from WLAN to E-UTRAN.

Thresh_{BackhRateDLWLAN, High}
This specifies the backhaul available downlink bandwidth threshold used by the UE for traffic steering from E-UTRAN to WLAN.

Thresh_{BackhRateULWLAN, Low}
This specifies the backhaul available uplink bandwidth threshold used by the UE for traffic steering from WLAN to E-UTRAN.

Thresh_{BackhULWLAN, High}
This specifies the backhaul available uplink bandwidth threshold used by the UE for traffic steering from E-UTRAN to WLAN.

Thresh_{BeaconRSSIWLAN, Low}
This specifies the Beacon RSSI threshold used by the UE for traffic steering from WLAN to E-UTRAN.

Thresh_{BeaconRSSIWLAN, High}
This specifies the Beacon RSSI threshold used by the UE for traffic steering from E-UTRAN to WLAN.

Tsteering_{WLAN}
This specifies the timer value Tsteering_{WLAN} during which the rules should be fulfilled before starting traffic steering between E-UTRAN and WLAN.

WLAN Identifiers
Only the SSIDs, BSSIDs and HESSIDs which are provided in this parameter shall be considered for traffic steering between E-UTRAN and WLAN based on the rules in this subclause.

As noted above, because of the proliferation of devices that have both Wi-Fi and 3GPP mobile broadband support, offloading traffic to the Wi-Fi network is becoming very interesting, both from the user's and the operator's perspectives. The main difference between traffic steering to and from Wi-Fi, as compared to steering between 3GPP networks (or 3GPP-“friendly” networks such as CDMA2000), is that it is generally the terminal that decides when it shall select a Wi-Fi AP, while in the latter case it is the network that is in charge of the network access decisions. Due to technical and historical reasons, the Wi-Fi deployment scenario is in many cases fundamentally different than the cellular deployment.

### SUMMARY

Special considerations are to be made when integrating Wi-Fi to 3GPP networks. In embodiments described herein, mechanisms between a 3GPP RAN node (e.g., eNB) and a WLAN are defined, to enable optimal steering of traffic while considering both the end user's and the network's performance. Further, mechanisms between a UE and the 3GPP RAN node and/or WLAN are also defined. These mechanisms make it possible for the 3GPP RAN node to determine that terminals associated to it (in connected or idle mode) are connected to WLAN and, in some embodiments, to do so selectively, by subscribing to connection status reports for one or more wireless terminals.

According to some embodiments, a method in one or more nodes of a wide-area cellular network includes sending, to a first node in a WLAN, a request for a subscription to connection status information for one or more wireless terminals. The method also includes subsequently receiving a first report from the WLAN. The first report indicates that a first wireless terminal, covered by the subscription request, has connected to the WLAN. The method further includes determining, based on the first report, to hold context information for the first wireless terminal, rather than releasing the context information.

According to some embodiments, a method in one or more nodes of a WLAN includes receiving, from a first node in a wide-area cellular network, a request for a subscription to connection status information for one or more wireless terminals. The method also includes subsequently determining that a first wireless terminal covered by the subscription request has connected to the WLAN and sending a first report to the wide-area cellular network, the first report indicating that the first wireless terminal has connected to the WLAN. The method further includes subsequently determining that the first wireless terminal covered by the subscription request has disconnected from the WLAN and sending a second report to the wide-area cellular network. The second report indicates that the first wireless terminal has disconnected from the WLAN.

Other embodiments may include apparatuses (e.g. cellular network nodes and WLAN nodes), computer program products and computer-readable media corresponding to the methods summarized above.

### BRIEF DESCRIPTION OF THE DRAWINGS

Exemplary embodiments of the techniques introduced in this document are described below with reference to the following figures, in which:

FIG. 1 illustrates the E-UTRA architecture.

FIG. 2 illustrates the split between the E-UTRAN and the EPC.

FIG. 3 illustrates a simplified Wi-Fi user plane architecture.

FIG. 4 illustrates a simplified Wi-Fi control plane architecture.

FIG. 5 illustrates the ANDSF architecture.

FIG. 6 shows an example of an E-UTRAN architecture as part of an LTE-based communications system.

FIG. 7 is a block diagram of a terminal device according to some embodiments of the disclosed techniques.

FIG. 8 is a block diagram of a RAN node according to some embodiments of the disclosed techniques.

FIG. 9 is a block diagram of a WLAN AP according to some embodiments of the disclosed techniques.

FIG. 10 is a process flow diagram illustrating several of the techniques described herein.

FIG. 11 is a signal flow diagram illustrating an example of the described techniques.

FIG. 12 is a signal flow diagram illustrating another example of the described techniques.

FIG. 13 is a process flow diagram illustrating an example method in one or more nodes of a cellular network.

FIG. 14 is a process flow diagram illustrating an example method in one or more nodes of a WLAN.

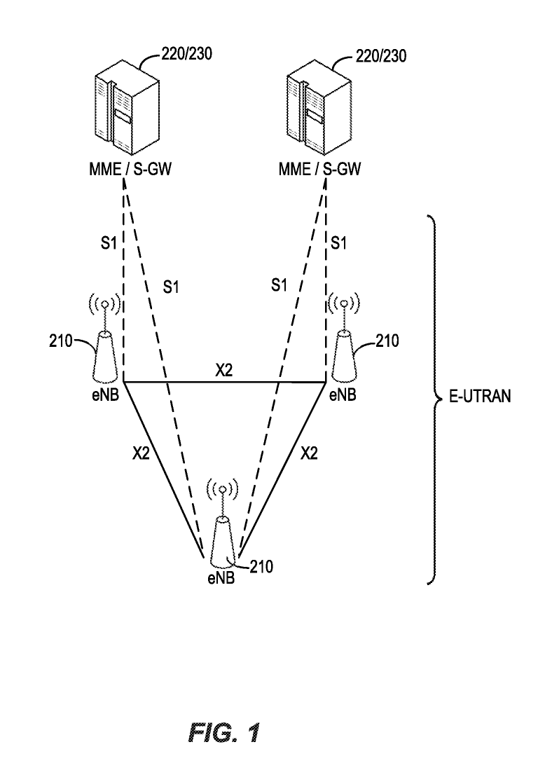

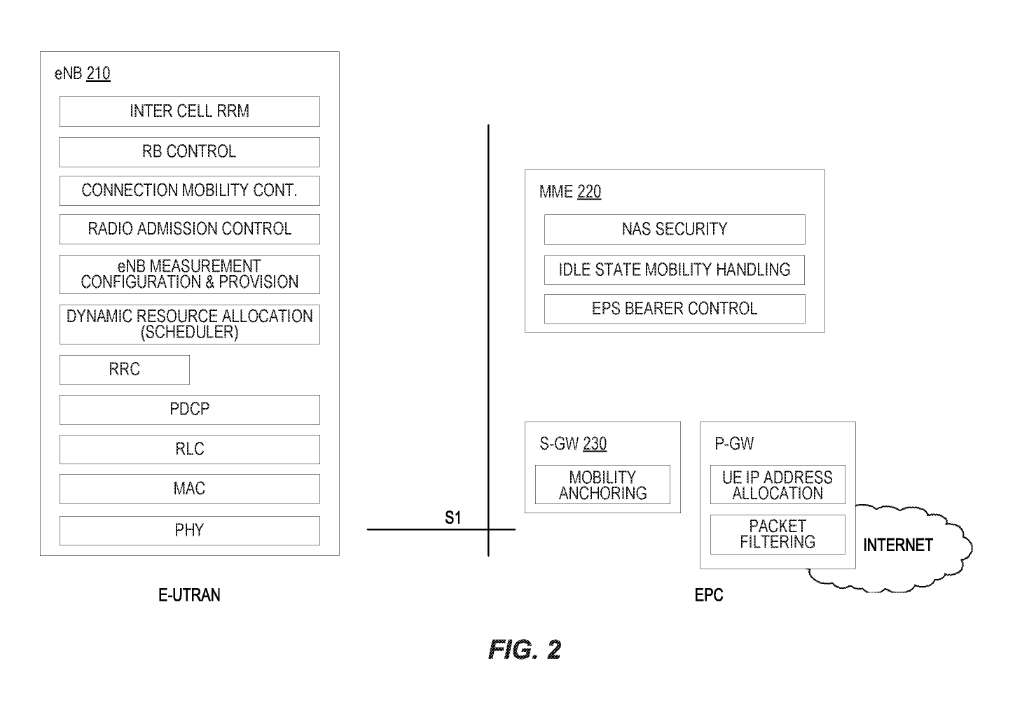

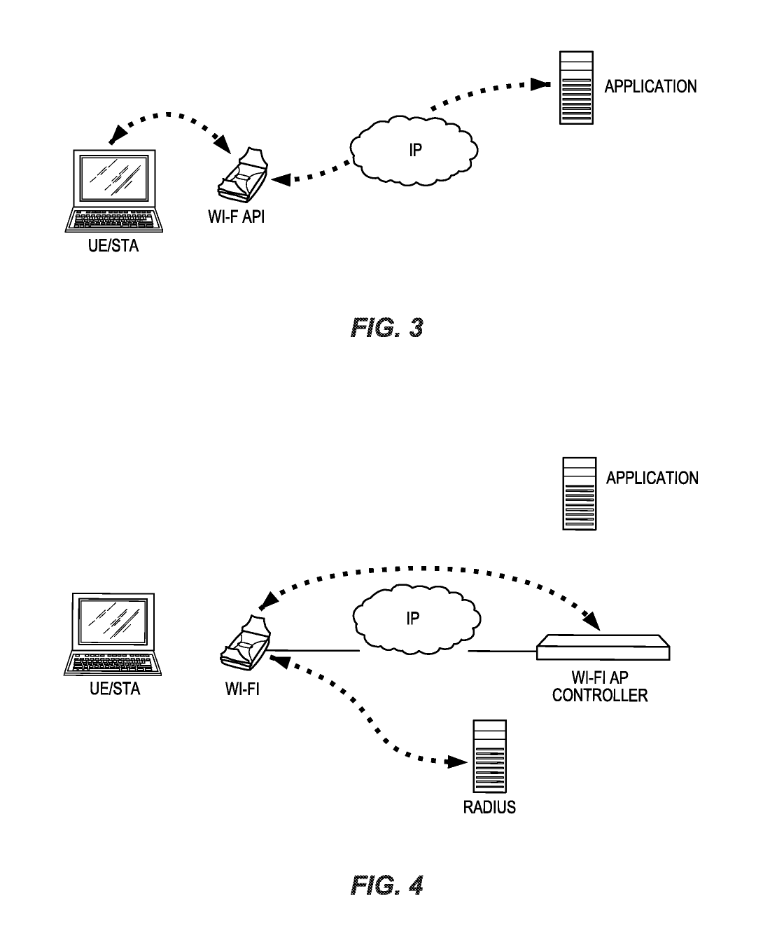

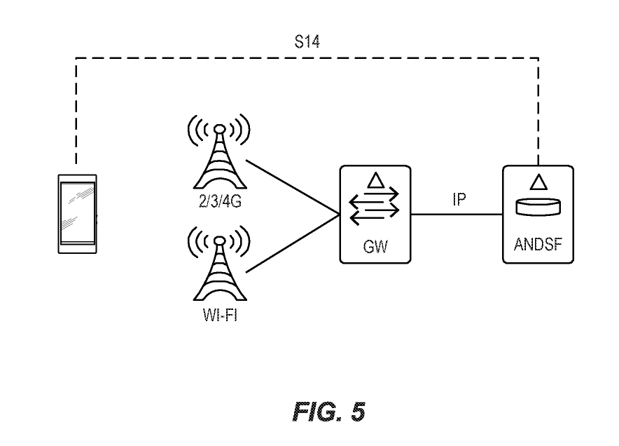

### DETAILED DESCRIPTION

Embodiments of the inventive concepts will now be described more fully hereinafter with reference to the accompanying drawings. These inventive concepts may, however, be embodied in many different forms and should not be construed as limited to the embodiments set forth herein. Rather, these embodiments are provided so that this disclosure will be thorough and complete, and fully convey the scope of present inventive concepts to those skilled in the art. It should also be noted that these embodiments are not mutually exclusive. Components from one embodiment may be tacitly assumed to be present or used in another embodiment.

As used herein, the terms “mobile terminal,” “wireless terminal,” “user equipment,” or “UE” may be used to refer to any device that receives data from and transmits data to a communication network, any of which may be for example, a mobile telephone (“cellular” telephone), laptop/portable computer, pocket computer, hand-held computer, desktop computer, a machine to machine (M2M) or MTC type device, a sensor with a wireless communication interface, etc. Devices of any of these types may be adapted, according to known techniques and according to the additional techniques disclosed herein, for operation in a device-to-device (D2D) mode, where such operation may include the transmitting and receiving of certain signals that are similar to or identical with corresponding signals used when operating within a cellular network, i.e., in a device-to-base-station operating mode.

A cell in a wide-area cellular network such as the LTE network is associated with a RAN node, where a RAN node comprises in a general sense any node transmitting radio signals in the downlink (DL) to a terminal device and/or receiving radio signals in the uplink (UL) from a terminal device. Some example RAN nodes, or terms used for describing RAN nodes, are base station, eNodeB, eNB, NodeB, macro/micro/pico/femto radio base station, home eNodeB (also known as femto base station), relay, repeater, sensor, transmitting-only radio nodes or receiving-only radio nodes. A RAN node may operate or at least perform measurements in one or more frequencies, carrier frequencies or frequency bands and may be capable of carrier aggregation. It may also be a single-radio access technology (RAT), multi-RAT, or multi-standard node, e.g., using the same or different base band circuitry for different RATs.

It should be noted that unless otherwise indicated, the use of the general term “network node” as used herein refers to a RAN node, such as a base station, an eNodeB, a network node in the RAN responsible for resource management, such as a radio network controller (RNC), a core network node, such as an MME or SGW, or a WLAN AP or WLAN AC.

The signaling described is either via direct links or logical links (e.g. via higher layer protocols and/or via one or more network nodes). For example, signaling from a coordinating node may pass another network node, e.g., a radio node.

Note that although terminology from specifications for the E-UTRAN is used to exemplify embodiments of the inventive concepts, this should not be seen as limiting the scope of the presently disclosed techniques to only these systems. Devices designed for use in other wireless systems, including variations and successors of 3GPP LTE systems, and WCDMA (UMTS) systems, WiMAX (Worldwide Interoperability for Microwave Access), UMB (Ultra Mobile Broadband), HSDPA (High-Speed Downlink Packet Access), GSM (Global System for Mobile Communications), etc., may also benefit from exploiting embodiments of present inventive concepts disclosed herein.

In the discussion that follows, specific details of particular embodiments of the present invention are set forth for purposes of explanation and not limitation. It will be appreciated by those skilled in the art that other embodiments may be employed apart from these specific details. Further, in some instances detailed descriptions of well-known methods, nodes, interfaces, circuits, and devices are omitted so as not obscure the description with unnecessary detail. Those skilled in the art will appreciate that the functions described may be implemented in one or in several nodes. Some or all of the functions described may be implemented using hardware circuitry, such as analog and/or discrete logic gates interconnected to perform a specialized function, ASICs, PLAs, etc. Likewise, some or all of the functions may be implemented using software programs and data in conjunction with one or more digital microprocessors or general purpose computers. Where nodes that communicate using the air interface are described, it will be appreciated that those nodes also have suitable radio communications circuitry. Moreover, the technology can additionally be considered to be embodied entirely within any form of computer-readable memory, including non-transitory embodiments such as solid-state memory, magnetic disk, or optical disk containing an appropriate set of computer instructions that would cause a processor to carry out the techniques described herein.

Hardware implementations of the present invention may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors and/or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

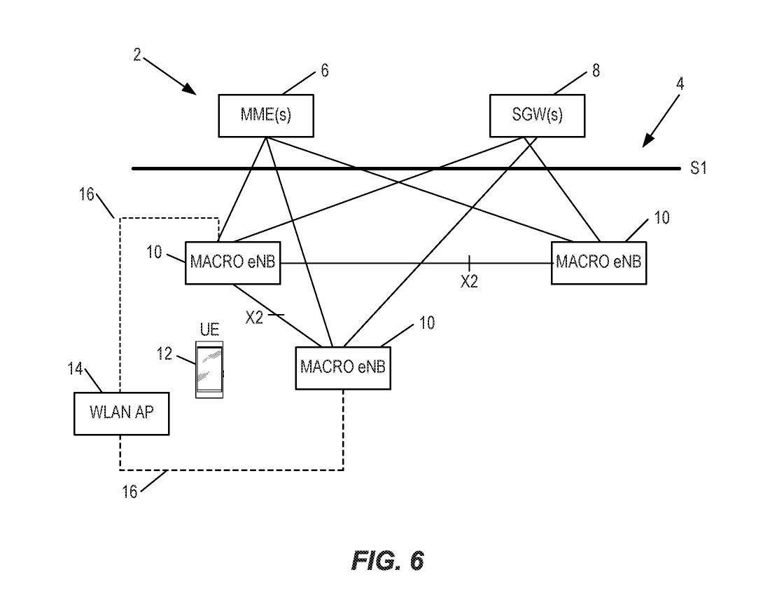

FIG. 6 shows an example diagram of an E-UTRAN architecture, as part of an LTE-based communications system 2. Nodes in the core network 4 include one or more MMEs 6, a key control node for the LTE access network, and one or more SGWs 8, which route and forward user data packets while acting as mobility anchors. MMEs 6 and SGWs 8 communicate with base stations 10, which in 3GPP documentation are referred to as eNBs or eNodeBs, over an interface, for example an S1 interface.

The eNBs 10 can include the same or different categories of eNBs, e.g. macro eNBs, and/or micro/pico/femto eNBs. The eNBs 10 communicate with each other over an interface, for example an X2 interface. The S1 interface and X2 interface are defined in the LTE standard. A UE 12 can receive downlink data from and send uplink data to one of the base stations 10 with that base station 10 being referred to as the serving base station of the UE 12. A WLAN AP 14 that is part of a WLAN is also shown in FIG. 6, although it will be appreciated that the WLAN and AP 14 are not part of the E-UTRAN architecture. As is known in the art, the UE 12 may be capable of aggregating multiple carriers from a single eNB 10 or multiple eNBs 10, and, in accordance with certain embodiments, the UE 12 is capable of aggregating a carrier from the LTE network 2 with a carrier from the WLAN AP 14.

In addition to developing the standards for access selection and traffic steering described in the background section above, the 3GPP has also initiated a study item entitled “Multi-RAT Joint Coordination,” in the 3GPP RAN3 TSG, to facilitate interworking between WLAN and 3GPP networks. The scope and requirements for this study item have been defined to include a focus on non-integrated 3GPP/WLAN nodes, since integrated nodes (i.e., individual nodes that provide both 3GPP and WLAN radio access services) are a matter of implementation. Among the requirements of this study is an investigation of potential enhancements of RAN interfaces and procedures to support the joint operation among different RATs, including WLAN. It has also been agreed that (i) the coordination involving WLAN and 3GPP is the priority of the study item and (ii) the statements on 3GPP/WLAN must complete work performed by the RAN2 TSG. This complementariness can be achieved by the specification of an interface between the E-UTRAN and WLAN.

Thus, in order to implement some of the various embodiments described herein, a communication path is established between the WLAN AP 14 and at least one of the nodes 10 in the LTE network 2, so that a dedicated connection can be established between the nodes. This is shown in FIG. 6 as interface 16. It will be appreciated that this connection would typically be established via the WLAN AP's 14 connection to a broadband network, such as the Internet, rather than there being a direct (e.g., air interface) signaling connection between the AP 14 and eNB 10. Similar interfaces may be established between one node 10 and multiple WLAN APs 14. It will also be appreciated that where the AP 14 is within the coverage area of several eNBs 10, the AP 14 may have separate interfaces to each of those eNBs 10.

Inter-node interfaces between pairs of nodes 10, 14 may use a peer to peer interface, i.e., an interface that connects the two nodes directly. Alternatively, inter-node interfaces could connect the two nodes while passing through other network nodes.

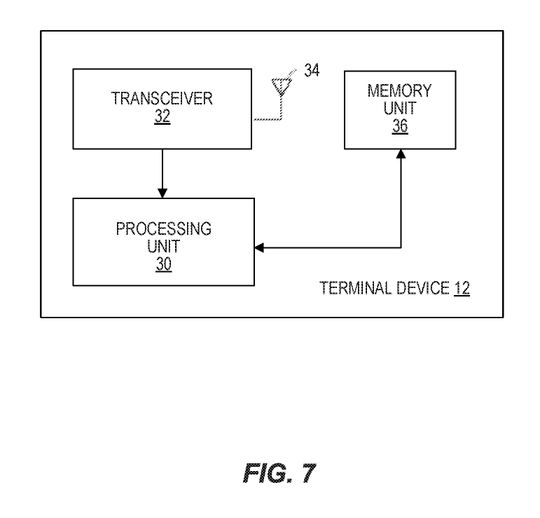

FIG. 7 shows a terminal device 12, which may be an LTE UE for example, which can be adapted for use in one or more of the non-limiting example embodiments described. The terminal device 12 comprises a processing unit 30 that controls the operation of the terminal device 12. The processing unit 30 is connected to a receiver or a transceiver 32 (which comprises a receiver and a transmitter) with associated antenna(s) 34 that are used to receive signals from or both transmit signals to and receive signals from two different types of radio access network (i.e. two radio access networks that are operating according to different RATs), such as RAN node 10 in the LTE network 2 and WLAN AP 14 in a WLAN. The terminal device 12 also comprises a memory unit 36 that is connected to the processing unit 30 and that stores computer program code and other information and data required for the operation of the terminal device 12. Together, the processing unit 30 and the memory unit 36 may be referred to as a processing circuit.

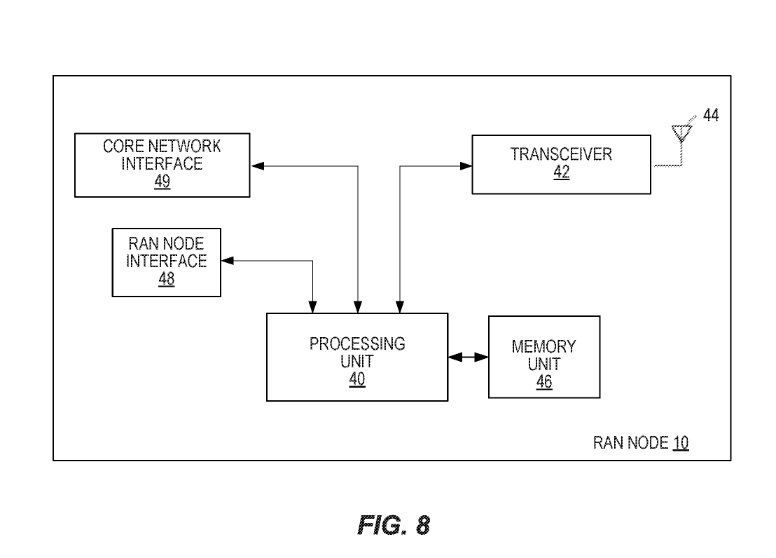

FIG. 8 shows a RAN node 10, that can be adapted for use in embodiments described herein. The RAN node 10 is a cellular network node, such as a base station, a NodeB, or an eNodeB. The RAN node 10 comprises a processing unit 40 that controls the operation of the base station 10. The processing unit 40 is connected to a transmitter or a transceiver 42 (which comprises a receiver and a transmitter) with associated antenna(s) 44 that are used to transmit signals to, and receive signals from, terminal devices 12 in the network 2. The RAN node 10 also comprises a memory unit 46 that is connected to the processing unit 40 and that stores computer program code and other information and data required for the operation of the RAN node 10. Together, the processing unit 40 and memory unit 46 may be referred to as a processing circuit. The RAN node 10 also includes components and/or circuitry 48 for allowing the RAN node 10 to exchange information with other RAN nodes 10 (for example via an X2 interface) and components and/or circuitry 49 for allowing the RAN node 10 to exchange information with nodes in the core network 4 (for example via the S1 interface). It will be appreciated that RAN nodes for use in other types of network (e.g. UTRAN or WCDMA RAN) will include similar components to those shown in FIG. 8 and appropriate interface circuitry 48, 49 for enabling communications with the other network nodes in those types of networks (e.g. other base stations, mobility management nodes and/or nodes in the core network).

In an example implementation, the processing circuit 40, 46 of the RAN node 10 is adapted to send, to a first node 14 in a WLAN, a request for a subscription to connection status information for one or more wireless terminals and subsequently receive a first report from the WLAN, the first report indicating that a first wireless terminal 12, covered by the subscription request, has connected to the WLAN. The processing circuit 40, 46 is configured to determine, based on the first report, to hold context information for the first wireless terminal 12, rather than release the context information. One advantage of this and similar embodiments is that if the RAN node 10 holds the context information, it can continue to control the first wireless terminal 12 and/or maintain a connection with the first wireless terminal 12. For example, maintaining the connection with the first wireless terminal enables the RAN node to control if and when the UE uses the WLAN so as to e.g. control if and when the wireless terminal should route traffic via the WLAN and via the RAN node. Thus the RAN node may e.g. identify, based on load of the RAN node/LTE network and/or the WLAN, if it would be beneficial for the first wireless terminal to disconnect from the WLAN and therefore trigger the wireless terminal to disconnect from the WLAN. According to a further example, even if the RAN nodes connection with the first wireless terminal is released, the RAN node can still hold context information for the first wireless terminal and, via a connection between the RAN node and the WLAN, monitor the first wireless terminals operations and experienced performance while connected to the WLAN. The RAN node could then influence how the first wireless terminal behaves while connected to the WLAN e.g. by indicating to the WLAN whether it should maintain its connection with the first wireless terminal or release its connection with the first terminal so as to steer the wireless terminal back to the LTE network. Also, since coverage of a WLAN AP is in general small in comparison to the coverage of LTE, the wireless terminal may remain within WLAN coverage only for a short period of time. By having the RAN node maintain the context information, overhead and delay associated with the RAN node reestablishing a connection with the wireless terminal when it leaves the WLAN AP coverage can be reduced or avoided.

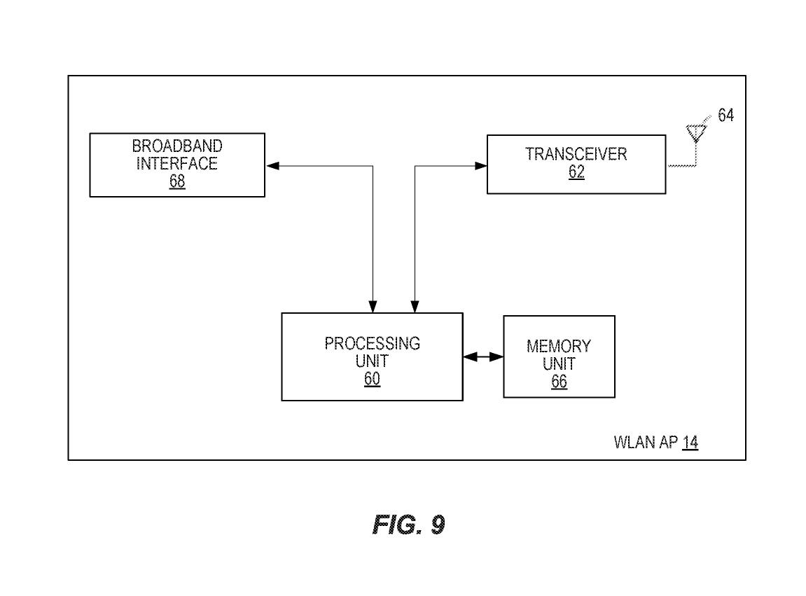

FIG. 9 shows an example of a WLAN node, in this case a WLAN AP 14, which can be used in the embodiments described herein. The AP 14 comprises a processing unit 60 that controls the operation of the AP 14. The processing unit 60 is connected to a transmitter or a transceiver 62 (which comprises a receiver and a transmitter) with associated antenna(s) 64 that are used to transmit signals to, and receive signals from, terminal devices 12. The AP 14 also comprises a memory unit 66 that is connected to the processing unit 60 and that stores computer program code and other information and data required for the operation of the AP 14. Together, the processing unit 60 and memory unit 66 may be referred to as a processing circuit. AP 14 also includes components and/or circuitry 68 for connecting AP 14 to a telephone line or other network connection.

In an example implementation, the processing circuit 60, 66 of the WLAN AP 14 is adapted to receive, from a first node 10 in a wide-area cellular network, a request for a subscription to connection status information for one or more wireless terminals, subsequently determine that a first wireless terminal 12 covered by the subscription request has connected to the WLAN and send a first report to the wide-area cellular network. The first report indicates that the first wireless terminal 12 has connected to the WLAN. The processing circuit 60, 66 is also adapted to subsequently determine that the first wireless terminal 12 covered by the subscription request has disconnected from the WLAN and send a second report to the wide-area cellular network. The second report indicates that the first wireless terminal has disconnected from the WLAN. One advantage of the second report is that the node of the wide-area cellular network can release the UE context of the first wireless terminal 12 and move it to IDLE mode if the first wireless terminal 12 is no longer connected to the WLAN. This can be conditioned on whether the first wireless terminal 12 has no active traffic in LTE.

It will be appreciated that only the components of the terminal device 12, RAN node 10, and AP 14 required to explain the embodiments presented herein are illustrated in FIGS. 7, 8, and 9.

With the traffic steering mechanisms described in the background section, the cellular network RAN (3GPP RAN) is influencing, and to some degree controlling, the terminal's access network selection and/or traffic steering decisions between 3GPP and WLAN. However, using these techniques alone, the 3GPP RAN has limited information regarding whether a terminal is selecting and/or steering traffic to WLAN. With this limited information, the 3GPP RAN will not be able to take informed radio resource management (RRM) decisions. For example, the 3GPP RAN may not be able to provide suitable thresholds to a terminal due to this lack of knowledge—this can result in poor access selection and/or traffic steering decisions, which may in turn lead to poor user experiences. Further, the 3GPP RAN may not know whether or not the connection between the 3GPP RAN and the terminal can be released or not.

The embodiments described above address these problems. Such embodiments involve the exchange of reports indicating whether a wireless terminal is connected to a WLAN. According to some embodiments, mechanisms between a 3GPP RAN node (e.g., eNB) and a WLAN are defined, as well as mechanisms between a UE and the 3GPP RAN node and/or WLAN. These mechanisms make it possible for the 3GPP RAN node to determine that terminals associated to it (in connected or idle mode) are connected to WLAN.

According to the first mechanisms detailed below, a WLAN node (such as the WLAN AP 14 or other WLAN node) reports to the 3GPP network whether a terminal 12 has connected to the WLAN. This report may be triggered, for example, when a terminal 12 has connected to the WLAN. Other possible triggers are also detailed below. Further, it is explained how conditional reporting can be used to reduce the amount of signaling between WLAN AP 14 and the 3GPP network.

According to the second mechanisms detailed below, the terminal 12 reports to the WLAN a 3GPP cell identity (e.g., an E-UTRAN Cell Global Identifier, or E-CGI) so that the WLAN can identify which 3GPP RAN node the terminal 12 is associated to. In addition to this, the terminal 12 may report UE identities to the WLAN and/or the 3GPP RAN node 10, so that the 3GPP RAN node 10 is capable of identifying which terminal associated to it (in connected mode or recently moved to idle) is transmitting over WLAN.

With these techniques, the 3GPP RAN node 10 will be given information regarding if and when a terminal 12 is connected to WLAN. This information can be used by the 3GPP network to take more appropriate Radio Resource Management (RRM) decisions, for example, which can result in enhanced system performance and/or user experience, etc. For instance, improved system performance can be achieved by adjusting the handling of terminals, such as by adjusting the parameter settings of the concerned terminal 12 and/or other terminals. It can also be used, for example, to decide whether or not to move the terminal 12 between different states/modes in the 3GPP networks, e.g., when deciding whether or not to move a terminal 12 to IDLE mode.

It should be noted that the descriptions that follow and/or the accompanying figures may indicate that a WLAN AP 14, in particular, is reporting to the 3GPP RAN node 10. It should be appreciated, however, that it may not be a WLAN AP that performs the reporting in some embodiments or instances. Instead, it may be some other WLAN node, such as a WLAN AC.

The 3GPP RAN node 10 may utilize the information received from the WLAN node 14 in handling the connection between the 3GPP RAN node 10 and the terminal 12. For example, the 3GPP RAN node 10 may release the connection between the 3GPP RAN and the terminal 12 if it has been indicated to the 3GPP RAN node 10 that the terminal 12 has successfully connected to a WLAN AP 14.

It will be appreciated that being “connected” to the WLAN can mean any of several different things, as exemplified by the existence of one or more of the below conditions:
802.11 authentication (Authentication to the WLAN AP) has been completed or is under way;
802.1x EAP-SIM authentication (Authentication to the AAA-servers) has been completed or is under way;
Four way hand-shake between the terminal and the WLAN has been completed;
An IP address has been assigned to the terminal in WLAN;
A Public Data Network (PDN) connection has been established through the WLAN, i.e., a connection between the terminal and the PDN gateway has been established;
Data traffic has been started through the WLAN.

The WLAN AP 14 may report to the 3GPP RAN node 10 that a terminal 12 has connected to it based on certain triggers, according to some embodiments. Below, a set of example triggers are described. Note that one or several of the below triggers may be applied, in various embodiments or instances.

1. Connection Procedure Completion

According to this trigger, the WLAN AP 14 will trigger a report when the terminal 12 has completed a connection procedure.

The WLAN AP 14 may send a report to the 3GPP RAN node 10 upon successfully completed connection procedures. This means, for example, that the terminal 12 has completed one or more of the connection procedures described in the list provided above. It is beneficial for the 3GPP RAN node 10 to know that a terminal 12 has successfully completed the WLAN connection, since this may indicate that the terminal 12 now can be served by the WLAN AP 14 and that the 3GPP RAN node 10 can release the connection to the terminal 12, freeing up resources in the 3GPP RAN node 10.

In some embodiments or instances, unsuccessfully completed connection procedures are reported. A WLAN AP 14 may, for any of many different reasons, reject a terminal's connection attempt, e.g., because the load on the WLAN AP 14 is too high. That a terminal 12 has tried to connect, but failed, may also be useful information to the 3GPP RAN node 10. For example, if a certain WLAN AP 14 is rejecting a terminal 12, the 3GPP RAN node 10 may refrain from attempting any offloading of other terminals to that WLAN AP 14 for a certain period of time, under the assumption that the other terminals would also get rejected. By avoiding further offloading attempts, additional network signaling, terminal power consumption, etc., can be avoided.

2. Request Received from 3GPP Node

The 3GPP RAN node 10 may query the WLAN AP 14 whether a terminal 12 has connected to the WLAN AP 14 by sending a request to the WLAN AP 14. The request may be a general request regarding whether any terminal has connected to the WLAN AP 14, e.g., during the last time T.

The time T need not be explicitly indicated in the request (although it may), but may instead be calculated since the last query occurrence, i.e., if the 3GPP RAN node 10 queried the WLAN AP 14 at time T1 and at time T2, the WLAN would, in response to the query at time T2, indicate those terminals which have connected between time T1 and time T2. This will ensure that when the 3GPP RAN node 10 queries a WLAN AP 14 it will receive indications of all terminals that have connected since the last query and hence the 3GPP RAN node 10 has complete information about connections to the WLAN AP 14. Of course, at the first query received from a particular RAN node 10, there would not exist a time T1; for this case the WLAN AP 14 may apply a default time T1, e.g., T1 is set to be T2−Tdef where Tdef is set to a fixed value, which may be specified in a specification, provided by the 3GPP RAN node 10, decided by the WLAN AP 14, etc.

It would also be possible that the 3GPP RAN node 10 includes the time T in the query request, which allows the 3GPP RAN node 10 to decide how far back in time it is interested to know about completed connections. For example, if the 3GPP RAN node 10 tried to offload a terminal to a WLAN at a time T3, the 3GPP RAN node 10 may be interested in whether that particular terminal 12 is connected to the WLAN but may not be interested in whether terminals have connected to the WLAN prior to the time T3; hence, the 3GPP RAN node 10 may query the WLAN AP 14 to determine whether any terminals have connected to the WLAN AP 14 since time T3. This allows for reducing the amount of signaling between the WLAN and the 3GPP RAN node 10, as connection attempts which have occurred prior to T3 can be omitted, reducing signaling overhead.

3. Periodic Reporting

The WLAN may periodically report to the 3GPP RAN node 10 whether terminals have connected to the WLAN. The WLAN AP 14 may maintain a timer T, for example, and when this timer T expires the WLAN AP 14 triggers a report to the 3GPP RAN node 10 and restarts the timer.

The timer value may be determined by the WLAN AP 14 itself. However, the timer value may be configured by the 3GPP RAN node 10, in some embodiments. In these embodiments, the 3GPP RAN node 10 can evaluate how often the information is needed, e.g., once per ten seconds, and then configure the WLAN AP 14 to send a report to the 3GPP RAN node 10 with the wanted periodicity.

The periodic reporting is a simple approach that does not require a lot of signaling (e.g., compared to the request-based triggering, which requires the 3GPP RAN node 10 to request the reports), while at the same time keeping the 3GPP RAN node 10 up-to-date with information about whether terminals have connected to the WLAN AP 14.

4. Number of Connected UEs

The WLAN may report to the 3GPP RAN node 10 when the number of terminals connecting to it has passed a certain configurable threshold since the last reporting. For example, if this threshold is set to be 5, the WLAN will report when 5 terminals have connected to it since the last reporting.

In some embodiments, one or more conditions may need to be fulfilled before the WLAN AP 14 will include a particular terminal 12 in the report. A set of example conditions are provided below.

1. Terminal Support for 3GPP

Not all devices support 3GPP connectivity. For example, smartphones usually support both 3GPP RATs and WLAN while, for example, certain tablet devices may only support WLAN. It may not be meaningful for the report to include information indicating that a non-3GPP device 12 has completed a connection attempt, when the WLAN node informs the 3GPP RAN node 10 about connection attempts.

Hence, the WLAN AP 14 may consider the terminal's 12 3GPP connection capability when deciding whether to include them in the report. The WLAN AP 14 may, in these embodiments, only include information regarding terminals that are known to support 3GPP connectivity. This information may be made known to the WLAN node 14 from the terminal 12, i.e., the terminal 12 would indicate to the reporting WLAN node 14 (or another WLAN node that can then inform the reporting WLAN node) whether it supports 3GPP connectivity or not. Alternatively, this could be inferred from other information such as UE identity that can be mapped to a device/terminal type.

2. 3GPP Network Connection Status

The WLAN AP 14 (or other WLAN node) may consider the terminal's 12 connection status to the 3GPP network when determining whether to include a terminal in the report. For example, if the terminal 12 has an active connection to the 3GPP network (e.g., RRC CONNECTED in LTE, CELL_DCH/CELL_FACH/CELL_PCH in UMTS, etc.), the 3GPP network can control the terminal 12 using dedicated signaling. In those situations, then, it may be more meaningful for the 3GPP RAN to be aware that a particular terminal 12 has connected to WLAN. On the other hand, if the terminal 12 is in an IDLE state, then no dedicated signaling is supported in 3GPP and the 3GPP RAN is not aware of the terminal's presence in the 3GPP cell. Hence, it may be less meaningful for the 3GPP RAN to be informed about those terminals 12 that are in an IDLE state and that have connected to WLAN, compared to terminals 12 that have an active connection to the 3GPP network.

Accordingly, the WLAN AP 14 in some embodiments may only indicate to the 3GPP RAN node 10 when a terminal 12 in a 3GPP connected state has connected to the WLAN AP 14, but not include information about a terminal in an IDLE state in the report.

This can be achieved, for example, if the terminal 12 provides to the WLAN AP 14 an indication of the 3GPP network identity (such as the 3GPP cell ID) selectively, depending on which state the terminal 12 is in. For instance, the terminal 12 in some embodiments may only indicate to the WLAN AP 14 the 3GPP network identity if the terminal 12 is in a connected state but not when in an IDLE state. In this case, the WLAN AP 14 can implicitly know which state the terminal 12 is in depending on whether the terminal 12 indicates the 3GPP network identity. It would also be possible that the terminal 12 explicitly indicates its 3GPP state to the WLAN AP 14 and then the WLAN AP 14 will explicitly know the state of the terminal 12 in the 3GPP domain.

3. Request from the Terminal

The terminal 12 may request the WLAN to indicate to the 3GPP RAN node 10 that the terminal 12 has connected to the WLAN. The terminal 12 may indicate this to the WLAN node 14 during the connection to the WLAN node 14.

The terminal 12 may determine whether to request the WLAN to include it in the report based on its configuration as established by signaling from the 3GPP network. In this case, the 3GPP network can then decide whether the terminal 12 shall or shall not request the WLAN network to include it in the report. The knowledge of the 3GPP network identity such as cell/eNB ID will be useful to determine to what particular node the report has to be sent.

4. PLMN

The WLAN AP 14 may, in some embodiments or instances, only include a terminal 12 in the report if the Public Land Mobile Network (PLMN), or one of several PLMNs, that the terminal 12 is associated with or connected to is the same as for the 3GPP RAN node 10 the report is sent to.

The terminal 12 may indicate to the WLAN AP 14 the PLMN(s) that the terminal 12 is associated with or connected to during the connection procedure with the WLAN, for example. The WLAN AP 14 may know the PLMN(s) of a 3GPP RAN node 10 based on a configuration or by indication of the 3GPP RAN node 10.

The benefit of only including in the report information about terminals from the PLMN that the 3GPP RAN node 10 belongs to is that the 3GPP network node 10 does not necessarily need to know that terminals from another PLMN have connected to the WLAN. For example, if an operator X owns a 3GPP RAN X and an operator Y owns a 3GPP RAN Y, then the 3GPP RAN X may only be interested about whether terminals belonging to operator X are connecting to a WLAN AP 14, and not being interested in whether terminals belonging to operator Y are connecting to the WLAN AP 14.

5. Cause of WLAN Connection

The WLAN AP 14 may consider the cause for a terminal 12 connecting to the WLAN when determining whether to include the terminal 12 in the report. This may be beneficial, as the terminal 12 may connect to a WLAN AP 14 for different reasons. One reason where it is interesting for the RAN to know whether a terminal 12 connected to a WLAN is if the terminal 12 is connected to the WLAN due to a RAN controlled/influenced mechanism (e.g., due to an offloading mechanism as described in the background section). In contrast, if the terminal 12 connected to the WLAN AP 14 based on user preference (i.e., the end user forced/requested the terminal 12 to connect to the WLAN AP 14) then the 3GPP RAN may not be interested in knowing that the terminal 12 has connected, since the 3GPP RAN was not the trigger for the terminal's connection to the WLAN AP 14.

To enable this trigger the WLAN AP 14 needs to know the cause of the connection to the WLAN AP 14. This may be achieved by the terminal 12 providing an indication to the WLAN AP 14 during or after the connection procedure. It may also be possible that the WLAN AP 14 implicitly knows the cause by the type of connection the terminal 12 is establishing in the WLAN domain. For example, if the terminal 12 is establishing an S2a/S2b/S2c connection through the WLAN then the WLAN AP 14 may be able to assume that the terminal 12 is connecting to the WLAN AP 14 due to an operator controlled/influenced (i.e., RAN controlled/influenced) mechanism. Further, the terminal 12 may be configured to indicate to the WLAN AP 14 (either directly or via another node such as the WLAN AC) the 3GPP RAN node 10 identity if the terminal 12 connects to a WLAN based on an operator controlled/influenced mechanism (but be configured to not provide such indication when the terminal 12 connects to the WLAN AP 14 due to, e.g., an end-user trigger) and the WLAN AP 14 can then implicitly know that if the 3GPP RAN node 10 identity is provided, the terminal 12 has connected due to an operator controlled/influenced mechanism.

Any of several possible information elements may be included in the report sent by the WLAN node 14 to the 3GPP node 10. Following are a list of examples.

1. Terminal Identity

The WLAN AP 14 may inform the 3GPP RAN of an identity for the terminal 12. This may allow the 3GPP RAN to know not only that a terminal 12 has connected to WLAN but also which terminal 12 has connected. Possible identities include 3GPP Cell Radio Network Temporary Identifier (C-RNTI), International Mobile Subscriber Identity (IMSI), WLAN Media Access Control (MAC), IP address, an identifier common for the terminal's 3GPP and WLAN entity.

A generic identity may also or instead be included in the report. This identity may be provided by the 3GPP RAN node 10, e.g., the 3GPP RAN node 10 has indicated the generic identity to the terminal 12 and the terminal 12 indicates this to the WLAN AP 14 (e.g., during the connection procedure) and the WLAN AP 14 then indicates this to the 3GPP RAN. The benefit of the generic identity is that it can be terminal-specific and yet be applicable regardless of the terminal's state in 3GPP, which for example the C-RNTI may not be since the C-RNTI, even though being terminal-specific in a 3GPP cell, is released when the terminal 12 moves from CONNECTED to IDLE mode and hence is not applicable in IDLE mode.

2. Network Identity

The WLAN AP 14 may include an identity relevant for the WLAN network in the report. In case the 3GPP RAN node 10 is not already aware of where the report comes from, i.e., from which WLAN AP 14 the report comes, then including the WLAN network identity could help the 3GPP RAN to know from which WLAN AP 14 the report comes and hence to which WLAN AP 14 the terminal has connected.

The WLAN may also provide to the 3GPP RAN node 10 an indication of which PLMN and/or 3GPP cell a terminal 12 is associated with. This can be useful in case the WLAN node provides information relevant for all terminals that have connected to the WLAN, i.e., if the WLAN is not filtering out and reporting to a 3GPP RAN node 10 information relevant to the terminals 12 associated with the specific RAN node 10. In that case the 3GPP RAN node 10 may need to filter out the terminals 12 which are associated to it. Consider, for example, that the WLAN node 14 sends the same information to all 3GPP RAN nodes, i.e., information relevant for all terminals which are connected to the WLAN node 14, then the 3GPP RAN node may only be interested in information relevant for the terminals 12 which are associated with the 3GPP RAN node 10 itself, but not interested in information relevant to terminals which are associated to other 3GPP RAN nodes, therefore by indicating to the 3GPP RAN node 10 the PLMN and/or 3GPP cell a terminal 12 is associated with will allow the 3GPP RAN node 10 to do the filtering.

3. Time of Connection

The report may include a time for when the terminal 12 is connected. This is beneficial in the event that the report is sent some time after the terminal 12 has connected. The reported time may be in the form of an absolute time (e.g. 13:41:17).

4. Type of Connection

The WLAN AP 14 may indicate to the 3GPP RAN which type of connection the terminal 12 has connected with. The terminal 12 may connect to a WLAN AP 14 using, e.g., S2a/S2b/S2b connections or a non-seamless WLAN offload (NSWO) connection. This information may valuable for the 3GPP RAN to know, as it allows the 3GPP RAN to determine what would be the effect of steering the terminal 12 back to 3GPP. For example, it may be possible to steer a terminal 12 from WLAN to 3GPP with an S2a connection without creating interruptions in the terminal's 12 connection. However if a NSWO connection is steered, the terminal 12 may need to change IP-address with an interruption as consequence.

5. Connection Status

As noted above, a “connection” to WLAN can mean any of several different things, such as that authentication has been performed, data traffic has started flowing, etc. Thus, the WLAN AP 14 may include an optional field indicating what type of“connection” the user has performed. This additional info is mainly useful for handling abnormal cases where the offloading was not completed properly.

It will be appreciated, in view of the several techniques described above, that certain modifications to terminal behavior may be necessary or desired, to facilitate these techniques. For example, in order for the WLAN to transmit several of the reports described above to the 3GPP RAN node 10, the WLAN may in some implementations need to know to which 3GPP cell the terminal 12 is associated. Accordingly, in some embodiments, the terminal 12 is adapted to report the 3GPP cell identity (e.g., the E-CGI) to the WLAN, e.g., during any steps of WLAN association/authentication.

Likewise, in order for the 3GPP RAN node 10 to be able to identify which terminal the report is associated with, terminal identities should be in the report and recognizable at the 3GPP RAN node 10. Thus, in some embodiments, the terminal 12 sends its 3GPP identity and any other relevant information (such as PLMN, 3GPP cell ID, etc.) to the WLAN during any steps of the authentication/association procedures. The report described earlier would contain this identity and the 3GPP RAN node 10 is capable of identifying which terminal 12 is transmitting to the WLAN AP 14 sending the report.

In other embodiments, the terminal 12 reports its WLAN identity (e.g., a WLAN MAC address) during any steps of the radio connection setup in 3GPP, and the 3GPP RAN node 10 is then able to associate the WLAN identity with the UE context of the terminal 12. In that case, the report from WLAN to 3GPP RAN node 10 could contain the WLAN MAC address (available in the AP 14 after WLAN association, after which the 3GPP RAN node 10 can retrieve the UE context and identity the terminal 12 that is transmitting over WLAN.

In still other embodiments, a common identity is reported on both systems and associated to the UE context in 3GPP so that when the report from WLAN to 3GPP RAN node 10 is received, the eNB 10 is capable of retrieving the UE context and identify the terminal 12.

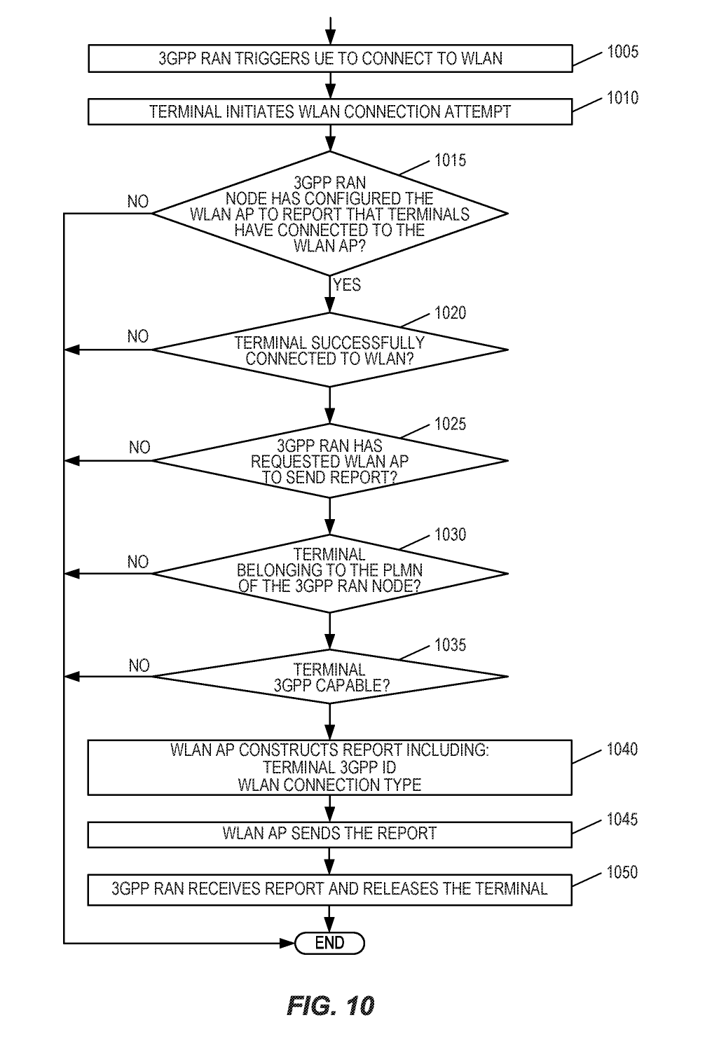

FIG. 10 is a flow diagram showing one example implementation of the techniques, where several of the mechanisms described herein are used. As seen at block 1005, a 3GPP RAN triggers a UE to connect to a WLAN. In response, the wireless terminal initiates a WLAN connection attempt, as shown at block 1010. Skipping ahead to block 1040, it can be seen that a WLAN AP constructs a report, including a 3GPP ID for the wireless terminal and a WLAN connection type. As seen at block 1045, the report is sent to the 3GPP network. A 3GPP network node receives the report, as shown at block 1050, and releases the terminal.

he sending of the report shown in block 1045 is conditioned, in the process shown in FIG. 10, on several factors. First, as shown at block 1015, the WLAN AP only sends reports if the 3GPP RAN node has configured the WLAN AP to report connections to the WLAN AP. As seen at block 1020, a report is only sent, in the illustrated technique, if a terminal has successfully connected to the WLAN. Next, as shown at block 1025, the WLAN AP in the illustrated process flow only sends a report in response to an explicit request from the 3GPP RAN. Further, as seen at block 1030, the report of a particular wireless terminal is sent only if the wireless terminal is associated with the 3GPP RAN node, i.e., belonging to the PLMN. Finally, the report for the wireless terminal is sent only if the wireless terminal is 3GPP capable, as shown at block 1035. It will be appreciated that any or all of the conditioning/filtering operations shown in the process flow of FIG. 10 may be omitted in some embodiments.

In several embodiments of the techniques and apparatus described above, a WLAN node 14 indicates to a 3GPP network node 10 that a terminal 12 (or terminals) has connected to the WLAN AP 14, based on one or more of several different triggers. Further, in some embodiments, some conditions are provided, which allow the WLAN AP 14 to omit from the report certain terminals 12 that may not be of interest to the 3GPP network.

As suggested above, it is beneficial for the 3GPP network to know whether a terminal 12 has connected to a WLAN or not. Consider for example a scenario where the 3GPP network is applying an access network selection and/or traffic steering procedure such as those described in the background section. In this scenario, the 3GPP network will be (more or less) in control of if and when the terminal 12 connects to WLAN. However one problem with previously standardized procedures is that if the traffic ends for a terminal 12, the 3GPP network will not know whether the traffic ended because the terminal steered traffic to WLAN, or whether the traffic because a particular service, such as a file download, ended. However, the 3GPP network may want to handle the terminal 12 differently depending on why the traffic ended. For example, the 3GPP network may want to keep a connection established to a terminal 12 that has steered its traffic to WLAN, so that it can steer the traffic back (e.g., if the 3GPP load becomes low). On the other hand, if the traffic ended because a service ended, then it would likely be better for the 3GPP network to terminate its connection to the terminal 12, to free up resources in the network.

Using the techniques described above, the 3GPP network can receive connection status reports related to terminals 12. However, these mechanisms can cause an unnecessary amount of connection status reports to the extent that they may provide reports that will not benefit the 3GPP network. These unnecessary reports will increase signaling overhead and processing load, etc.

The techniques detailed below provide the means for a 3GPP network to subscribe to connection status reports for a particular terminal 12 or group of terminals, according to some embodiments. This approach can be used to ensure that the 3GPP network will only receive terminal connection status reports that the 3GPP network finds relevant.

The techniques rely on the existence of an inter-node interface between WLAN and 3GPP nodes, as discussed above. The details of this inter-node interface, which is currently referred to in 3GPP as the Xw interface, are likely to be standardized.

With the subscription-based approach to sending and receiving connection status reports for terminals described below, it can be ensured that a 3GPP node will receive connection status reports relevant for those terminals and in those situations when the 3GPP network finds relevant, without sending unnecessary reports.

In some of the techniques described above, the wireless device reports a cell identifier to the WLAN, so that the WLAN knows where to send information. This approach requires changes to the WLAN signaling, e.g., as defined by the IEEE 802.11 standards. The solution described below does not require modifications at the IEEE 802.11 standardization so that the WLAN is able to inform the correct RAN node 10 (i.e., the one for which the subscription has been setup).

According to this subscription-based approach, a 3GPP network node (e.g., a RAN node 10 such as an LTE eNodeB (eNB), a UMTS Node B, a Radio Network Controller (RNC), etc., indicates to a WLAN node, such as a WLAN AP or WLAN AC, that it wants to be informed about the connection status for terminals. This can be described as the 3GPP network is requesting a subscription of the connection status of terminals.

The subscription setup can be done by the 3GPP network when, for example, the 3GPP network has or is about to send a configuration (or command) to a terminal 12, where the configuration/command is expected to make the terminal 12 steer traffic to WLAN.

The subscription setup request can contain one or more identifiers for terminals or groups of terminals for which the 3GPP network wishes to receive connection status reports. Different types of identifiers are possible, such as the MAC address of the terminal 12 in WLAN (or WLAN MAC address, as it will be referred to herein). The WLAN MAC address may be signaled from the terminal 12 to the 3GPP network at an earlier stage, e.g., when the terminal connects to 3GPP.

For example, the 3GPP network may explicitly indicate to the WLAN network which terminals for which the 3GPP network would like to know the connection status. For instance, the 3GPP network may signal that it wishes to know the connection status for a terminal 12—to do so, the 3GPP network would then provide an identifier for terminal 12.

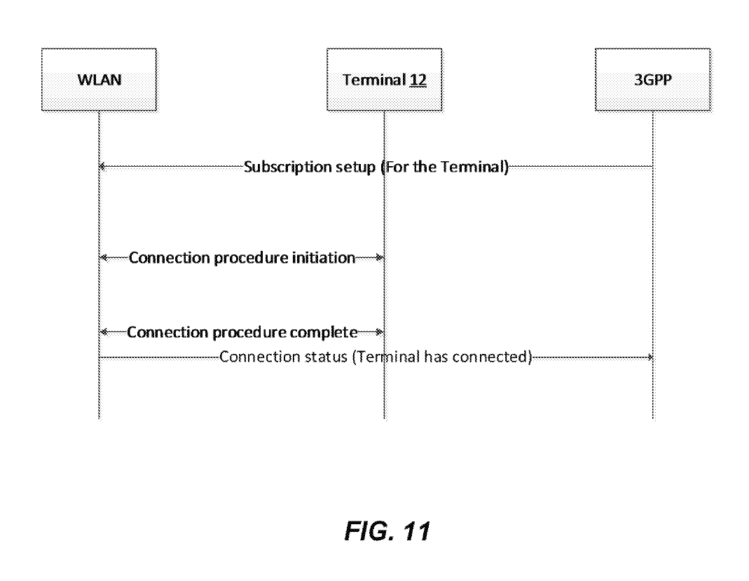

A flow diagram showing a high level description of this technique is shown in FIG. 11. In this figure, a 3GPP RAN node 10 sends a subscription indication to a WLAN, indicating that the 3GPP network wants to subscribe to the connection status for the terminal 12. At a later point in time, a connection procedure is initiated between the terminal 12 and the WLAN, and upon completion of this procedure the WLAN indicates the connection status for the terminal 12 to the 3GPP network—the reported connection status indicates that the terminal 12 has connected to the WLAN.

It is worth mentioning that the 3GPP RAN node 10 that sends the subscription setup message is not necessarily the same node that receives the Connection status message(s). In some embodiments or instances, however, the eNB sending the subscription setup is the same receiving the connection status.

In some other embodiments, the node sending the subscription setup is a node at the Operation Support Systems (OSS) domain, where the subscription setup contains a list of eNBs (potential neighbors, known at the OSS thanks to statistics of both systems), so that when a terminal 12 at any time connects to the WLAN, a Connection Status (the terminal 12 has connected) is reported to all the eNBs in this list.

References herein to a WLAN may refer to any of several different nodes in a WLAN, such as a WLAN AP, WLAN AC, etc. It should be noted that it would be possible that the subscription setup procedure is done with a different WLAN node than the WLAN node that is actually sending the report. For example, in some embodiments or instances the 3GPP RAN node 10 may set up the subscription at the WLAN AC, while the reports for this subscription are subsequently received from a WLAN AP 14.

As noted above, when this document refers to a terminal 12 being or becoming “connected” to WLAN, it may mean one or more of the following:
802.11 authentication (Authentication to the WLAN AP) has been completed or is under way;
802.1x EAP-SIM authentication (Authentication to the AAA-servers) has been completed or is under way;
Four way hand-shake between the terminal and the WLAN has been completed;
An IP address has been assigned to the terminal in WLAN;
A PDN connection has been established through the WLAN, i.e., a connection between the terminal and the PDN gateway;
Data traffic has been started through the WLAN.

It should be noted that it is described herein how a 3GPP network is subscribing for connection status reports from a WLAN node. However, this is just an example and it would be possible to apply this invention to other constellations of network nodes and/or RATs.

Subscription Setup

The subscription setup message is sent from the 3GPP network to the WLAN to indicate that the 3GPP network wants to be informed about the connection status for one or more terminals.

The subscription setup message may include one or more terminal identifiers which indicate those terminals for which the 3GPP network wants to subscribe to connection status reports. Further below, different possible terminal identifiers that can be used here will be discussed.

The subscription setup message may include a subscription identity. This identity may be decided by the 3GPP network and indicated to the WLAN network, or vice versa. The subscription identity can be used in subsequent communication between the 3GPP network and WLAN to refer to the subscription, e.g., to terminate the subscription.

The 3GPP network may further provide parameters related to the validity for the subscription. For example, a parameter may indicate for how long a time the subscription is valid.

In some embodiments, the subscription setup message may contain only a 3GPP node identity or other reference that can be used to find the 3GPP RAN node 10, e.g., an IP-address, etc. In this case, the WLAN reports to that node 10 whenever a new connection is made with any terminal 12. This may reduce the amount of signaling in the inter-node interface in the case of few 3GPP-WLAN neighbor relations. This node in that case can be a central node placed at the OSS, for example.

### Connection Status Report

As shown in FIG. 11, a connection status report is sent by the WLAN to the 3GPP node when a terminal 12 identified in the subscription request connects to the WLAN (or when any terminal 12 connects to the WLAN, in the event that the subscription request does not identify a specific terminal or group of terminals). This connection status report may include any one or more of the features/parameters discussed earlier, such as a terminal identity, a WLAN network identity, a time of connection, a type of connection, and an explicit indication of the connection status.

Additional parameters or features that may be included in a subscription-based approach to connection status reports include a subscription identity. In some embodiments or instances, the subscription identity is provided in addition to a terminal identity. In others, the subscription identity could potentially be used as an alternative to the terminal identity. For instance, in the event that there is only one terminal 12 associated with a particular subscription, the 3GPP network can deduce for which terminal 12 the connection report is relevant, without receiving a terminal identity in the report. Note that multiple subscriptions may be active at a given time, in some embodiments.

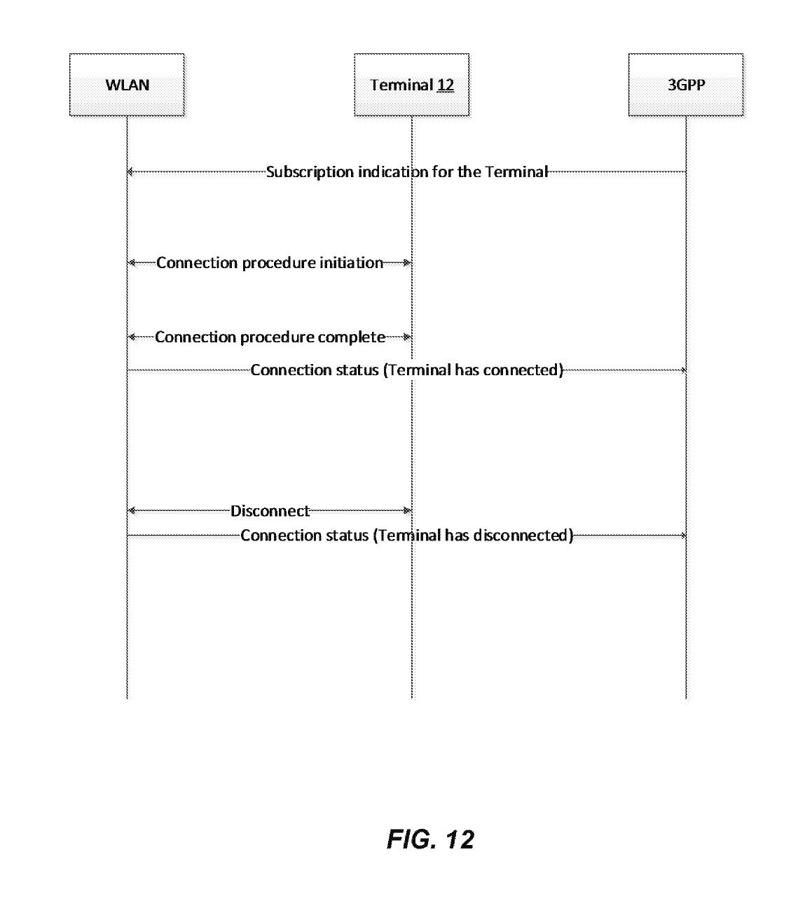

As discussed above, a “connection” to WLAN can mean several different things, such as whether authentication is performed or not, data traffic has started flowing, etc. Thus, the WLAN AP 14 may include an optional field indicating what type of“connection” the user has performed. This additional info is mainly useful for handling abnormal cases where the offloading was not completed properly. Note that it also possible, in some embodiments, for the WLAN to indicate to the 3GPP network that a terminal 12 has disconnected. An example flow diagram is shown in FIG. 12, where the WLAN first indicates to the 3GPP network that the terminal 12 has connected to the WLAN, based on the subscription. Later, when the terminal disconnects from the WLAN, the WLAN indicates this to the 3GPP network. In some embodiments, the reporting of the disconnecting may be contingent on whether the subscription is still active/valid.

It will be appreciated that it can be beneficial for the 3GPP network to know when the terminal 12 disconnects from the WLAN, for several reasons. For example, consider the scenario where the 3GPP network has kept the terminal 12 in a connected mode (e.g., RRC CONNECTED in LTE) while the terminal 12 is connected to the WLAN, to be able to control the terminal 12. If the terminal 12 in this scenario disconnects from the WLAN but the 3GPP network does not see any traffic from the terminal 12, then this would mean that the terminal 12 has no ongoing traffic (i.e., since the terminal 12 is disconnected from WLAN and naturally has no traffic there, and the 3GPP network does not see any traffic in the 3GPP domain for the terminal 12). In this scenario, the 3GPP network may release the connection to the terminal 12, under the assumption that it is no longer necessary to maintain the connection to the terminal 12 for the sake of controlling the terminal 12. Receiving an explicit indication of the disconnection would relieve the uncertainty, allowing the 3GPP network to make better decisions.

### Subscription Termination

In some embodiments of the subscription-based approach to connection status reporting, the 3GPP network may terminate the subscription for one or another reason. For example, if the 3GPP network configures to a terminal 12 to steer traffic to 3GPP, then the terminal 12 is not expected to connect to WLAN. Therefore the 3GPP network may terminate the subscription for that terminal 12.

The subscription termination message may include the subscription identity of the subscription which shall be terminated. However, it would also be possible that the 3GPP network terminates a subscription or modifies a subscription by sending a message that indicates for which terminal the subscription shall be terminated, by providing an identifier for that terminal 12.

The subscription termination message could be used to terminate more than one subscription by indicating a set of subscription identifiers and/or terminal identifiers.

In the event that the 3GPP network wants to terminate all its subscriptions it would be possible that the 3GPP network indicates a message to terminate all its subscriptions, in some embodiments, without necessarily indicating any subscription identifiers and/or terminal identifiers.

### The Validity of the Subscription

The subscription may have a limited validity period, during which period the WLAN considers that the 3GPP network shall be informed about terminals' connection status. This is beneficial, as the 3GPP network may only be interested in knowing connection status of terminals for a limited period of time.

Consider, for example, the scenario where the 3GPP network configures a terminal 12 to connect to a WLAN, then the 3GPP network may want to subscribe to connection status of the terminal 12 in the WLAN, but the 3GPP network may only be interested in knowing if the terminal 12 is connected to the WLAN for a limited period of time (e.g., the expected time it would take for the terminal 12 to connected to the WLAN). But if the connection attempt was not successful, the 3GPP network may not care whether the terminal 12 connects to the WLAN at a much later time (which may be due to other reasons than the configuration sent by the 3GPP network).

Therefore, the subscription may be valid for a certain period of time T_{validity}. The starting point of T_{validity} may be defined to be the time when the 3GPP network indicated that it wanted to set up the subscription, in some embodiments. When the subscription time has passed, the WLAN would consider that the 3GPP network does not want to receive terminal connection status information. When the validity time T_{validity} has passed, the WLAN may consider that the 3GPP network should not be informed about the terminal's 12 connection status in the WLAN.

The duration T_{validity} may be signaled to the WLAN from the 3GPP network. This could be included in the subscription setup message which would allow different T_{validity} for different subscriptions, e.g., the 3GPP network can indicate that it want to subscribe to the connection status of a terminal 12 for a time T_{validity,X}.

It would also be possible that the network indicates a common validity time. This means that the 3GPP network may indicate a time T_{validity} which should be applicable to all its subscriptions in a certain WLAN.

It may also be so that T_{validity} is not signaled but rather determined by the WLAN itself. For example, the subscription validity may be ended in case the interface between the 3GPP network node and WLAN is terminated/disabled/etc. This is beneficial, as it does not require the WLAN and/or 3GPP node to remember any subscriptions from previous interface-sessions between the two.

In some embodiments, the subscription may end when the WLAN has signaled to the 3GPP network N number of connection status reports for this subscription. For example, if the 3GPP network has subscribed to be informed of the connection status of a terminal 12, then the subscription in these embodiments would be valid until the WLAN has indicated the connection status for the terminal 12 N times. This number N could be indicated or hard coded, in various embodiments. The number could be set to 1, for example, to allow that the first connection a terminal 12 does to a WLAN is reported and then the subscription is not valid anymore. However, if it is wanted that the 3GPP network is informed about more than 1 connection status report then the value N can be larger. This could be the case, for example, when the 3GPP network wants to be informed when a terminal 12 both connects and disconnects from a WLAN, in which case N could be set to 2.

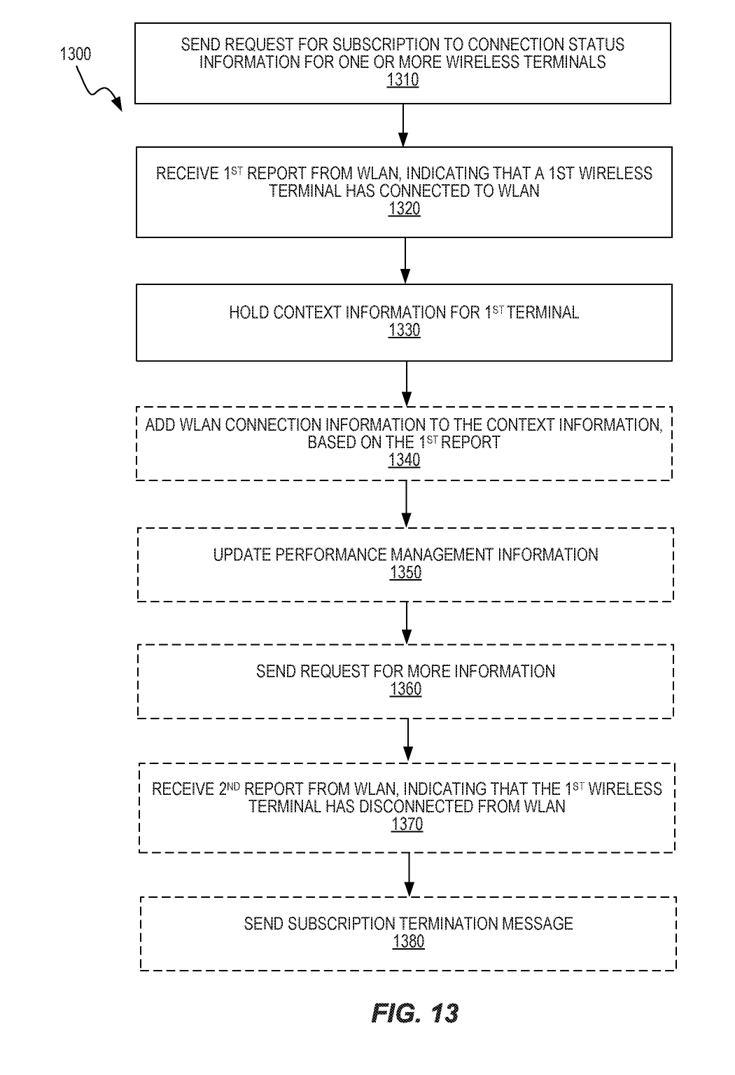

Given the above detailed examples, it should be appreciated that these techniques may be applied more generally. For instance, FIG. 13 is a process flow diagram illustrating a method 1300, according to the above-described techniques, as implemented in one or more nodes 10 of a wide-area cellular network.

As shown at block 1310, the illustrated method 1300 begins with sending, to a first node 14 in a WLAN, a request for a subscription to connection status information for one or more wireless terminals. As shown at block 1320, the method continues with subsequently receiving a first report from the WLAN. This first report indicates that a first wireless terminal, covered by the subscription request, has connected to the WLAN. In some embodiments, this first report may be received from a second node in the WLAN, i.e., from a node other than the one to which the subscription request was sent.

In some embodiments or instances, the request for the subscription includes one or more identifiers for wireless terminals or groups of wireless terminals, such that a given wireless terminal is covered by the subscription request only if it corresponds to at least one of the identifiers. In other embodiments or instances, the request for the subscription does not include any identifiers for wireless terminals or groups of wireless terminals, such that all wireless terminals are covered by the subscription request.

In some embodiments, the subscription has a corresponding validity period, such that a given wireless terminal is covered by the subscription request only during the validity period. In some embodiments, the request for the subscription includes an indicator of the validity period.

In some embodiments, the first report comprises a subscription identifier. In some embodiments, the request for the subscription comprises the subscription identifier.

The first report may be used for any of a number of purposes, in various embodiments. For instance, the one or more nodes in the cellular network may determine to hold the wireless terminal's context information instead of releasing it, in response to receiving the report. This is shown at block 1330 of FIG. 13. Note that releasing the context would be the normal behavior for wireless terminals that go to idle mode after steering to WLAN.

Optionally, the cellular network (e.g., the eNB) may not only hold but update this wireless terminal context information, e.g., by adding information indicating that the UE has a WLAN connection to a certain AP (and, perhaps, eventually adding additional info about this connection) (Block 1340). This assumes of course that the eNodeB wants to keep the UE Context while the UE is in WLAN. This could be beneficial in aggregation scenarios, where the eNodeB can keep its connection at the same time as the UE connects to WLAN.

Another possibility is that the cellular network could update internal eNodeB performance management (PM) data, in response to the first report (Block 1350). This updated data might include counters or events to be further collected by OAM/NMS for statistical analyses. Still another possibility is that the cellular network could use the first report to prepare the function that tries to steer wireless terminals back from WLAN to the eNodeB (e.g., after some overloading situation has finished). The first report could also trigger additional requests concerning that specific wireless terminal (Block 1360). For instance, an eNodeB could request the performance in WLAN of the wireless terminal, to decide whether to get it back. The connection notification provided in the first report would enable the eNodeB to trigger this request to the proper WLAN AP.

In some embodiments or instances, the illustrated method may further comprise receiving a second report from the WLAN, the second report indicating that the first wireless terminal, covered by the subscription request, has disconnected from the WLAN. This is shown at block 1370. This report can be used for similar purposes as above, e.g., to make decisions about context handling and/or to update performance management data.

As discussed earlier, the cellular network may determine, at some point, that it no longer has interest in receiving connection status update for a given terminal or group of terminals. Accordingly, block 1380 illustrates sending, to the WLAN, a message indicating that the subscription is to be terminated. A subscription might be terminated completely, in some embodiments or instances, or only with respect to one or more wireless terminals or groups of terminals, in others.

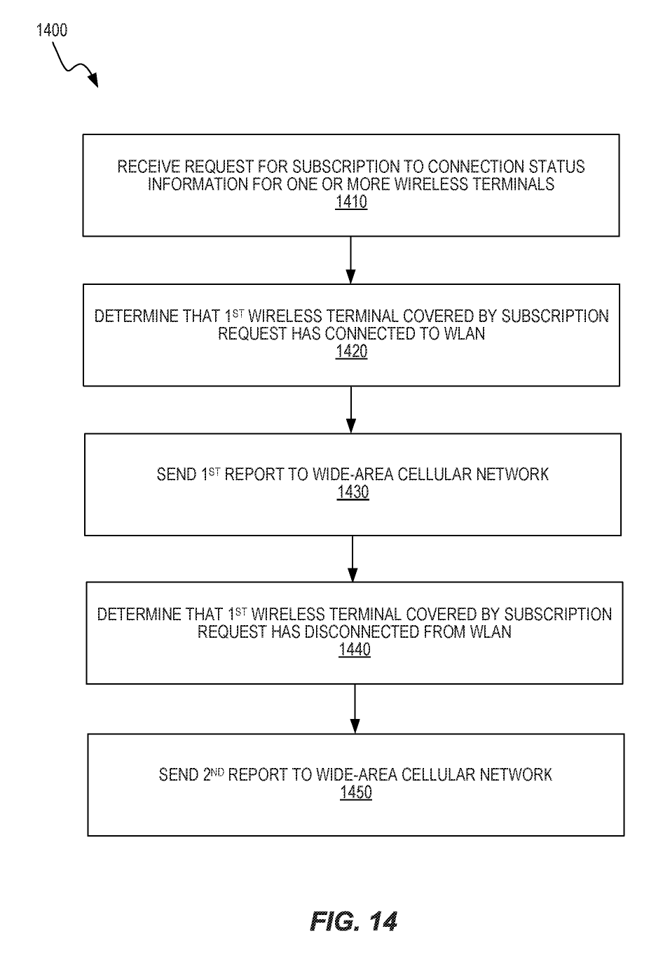

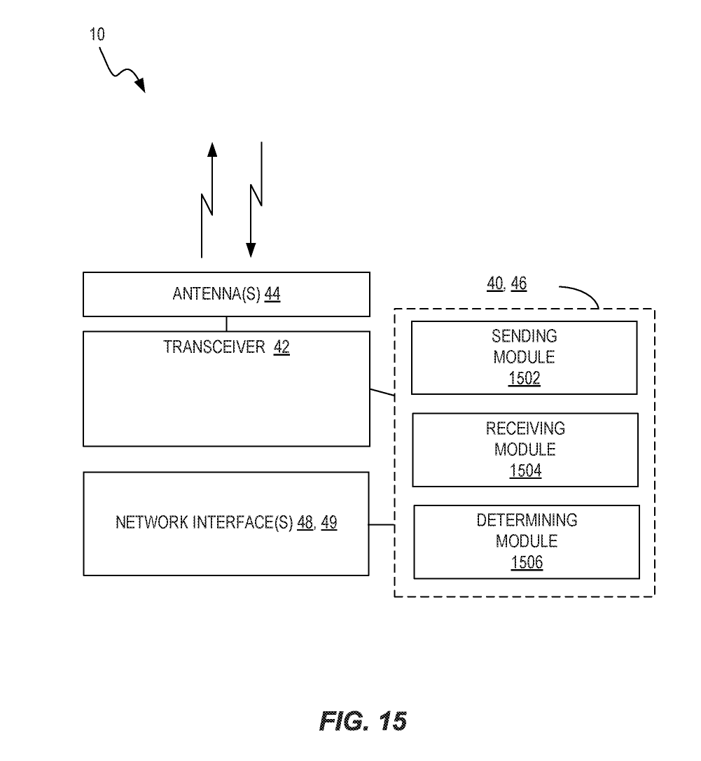

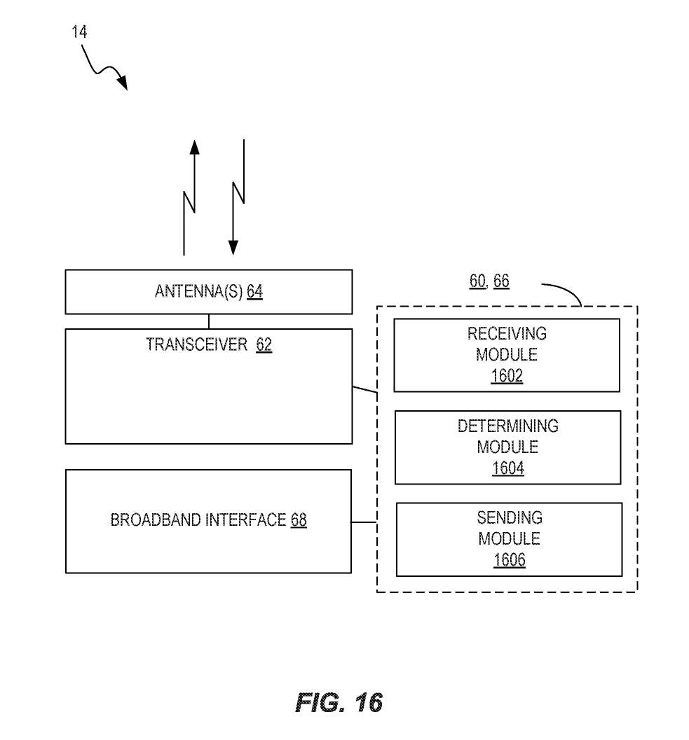

FIG. 14 is a process flow diagram illustrating an example method, according to the above-described techniques, as implemented in a node 14 of a WLAN, such as in a WLAN AP or WLAN AC.

As shown at block 1410, the illustrated method 1400 begins with receiving, from a first node in a wide-area cellular network, a request for a subscription to connection status information for one or more wireless terminals. As shown at block 1420, the method further comprises subsequently determining that a first wireless terminal covered by the subscription request has connected to the WLAN. In block 1430, the method includes sending a first report to the wide-area cellular network. This first report indicates that the first wireless terminal has connected to the WLAN.

In some embodiments, sending the first report to the wide-area cellular network comprises sending the first report to a second node in the wide-area cellular network, i.e., to a node other than the node that sent the subscription request.

In some embodiments, the request for the subscription includes one or more identifiers for wireless terminals or groups of wireless terminals, such that a given wireless terminal is covered by the subscription request only if it corresponds to at least one of the identifiers. In other embodiments or in other instances, the request for the subscription does not include any identifiers for wireless terminals or groups of wireless terminals, such that all wireless terminals are covered by the subscription request. In some embodiments, the subscription has a corresponding validity period, such that a given wireless terminal is covered by the subscription request only during the validity period. In some of these embodiments, the request for the subscription includes an indicator of the validity period. In others, the validity may be pre-configured.

In some embodiments, the first report comprises a subscription identifier. In some embodiments, the request for the subscription comprises the subscription identifier.

Reports may also be sent for disconnection events, in some embodiments. This is shown at blocks 1340 and 1350, which illustrate subsequently determining that the first wireless terminal covered by the subscription request has disconnected from the WLAN and sending a second report to the wide-area cellular network, respectively. This second report indicates that wireless terminal has disconnected from the WLAN.

In some embodiments or instances, the method may further comprise receiving, from the wide-area cellular network, a message indicating that the subscription is to be terminated, and then refraining from sending further reports for wireless terminals covered by the subscription request. It will be appreciated by the person of skill in the art that various modifications may be made to the above described embodiments without departing from the scope of the present invention. For example, although embodiments of the present invention have been described with examples that reference a communication system compliant to the 3GPP-specified LTE standards, it should be noted that the solutions presented may be equally well applicable to other networks. The specific embodiments described above should therefore be considered exemplary rather than limiting the scope of the invention. Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive.

In the present description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments have been described herein, with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) running on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure, and shall not be restricted or limited by the foregoing detailed description.

1-42. (canceled)

43. A method, in one or more nodes of a wide-area cellular network, the method comprising:
sending, to a first node in a wireless local-area network (WLAN) a request for a subscription to connection status information for one or more wireless terminals;
subsequently receiving a first report from the WLAN, the first report indicating that a first wireless terminal, covered by the subscription request, has connected to the WLAN; and
determining, based on the first report, to hold context information for the first wireless terminal, rather than releasing the context information.

44. The method of claim 43, wherein the request for the subscription includes one or more identifiers for wireless terminals or groups of wireless terminals, such that a given wireless terminal is covered by the subscription request only if it corresponds to at least one of the identifiers.

45. The method of claim 43, wherein the request for the subscription does not include any identifiers for wireless terminals or groups of wireless terminals, such that all wireless terminals are covered by the subscription request.

46. The method of claim 43, further comprising:
sending, to the WLAN, a message indicating that the subscription is to be terminated.

47. The method of claim 43, further comprising:
adding WLAN connection information to the context information, based on the first report.

48. The method of claim 43, further comprising:
updating performance management data, based on the first report.

49. The method of claim 43, further comprising:
requesting, from the WLAN, further information regarding the first wireless terminal, in response to the first report.

50. The method of claim 43, further comprising:
receiving a second report from the WLAN, the second report indicating that the first wireless terminal has disconnected from the WLAN.

51. A method, in one or more nodes of a wireless local-area network (WLAN), the method comprising:
receiving, from a first node in a wide-area cellular network, a request for a subscription to connection status information for one or more wireless terminals;
subsequently determining that a first wireless terminal covered by the subscription request has connected to the WLAN;
sending a first report to the wide-area cellular network, the first report indicating that the first wireless terminal has connected to the WLAN;
subsequently determining that the first wireless terminal covered by the subscription request has disconnected from the WLAN; and
sending a second report to the wide-area cellular network, the second report indicating that the first wireless terminal has disconnected from the WLAN.

52. The method of claim 51, wherein the request for the subscription includes one or more identifiers for wireless terminals or groups of wireless terminals, such that a given wireless terminal is covered by the subscription request only if it corresponds to at least one of the identifiers.

53. The method of claim 51, wherein the request for the subscription does not include any identifiers for wireless terminals or groups of wireless terminals, such that all wireless terminals are covered by the subscription request.

54. The method of claim 51, further comprising:
receiving, from the wide-area cellular network, a message indicating that the subscription is to be terminated; and
refraining from sending further reports for wireless terminals covered by the subscription request.

55. A cellular network node for use in a cellular network, comprising:
a transceiver configured to send and receive wireless signals;
interface circuitry configured to enable communication with other network nodes; and
a processing circuit configured to:
send, to a first node in a wireless local-area network (WLAN), a request for a subscription to connection status information for one or more wireless terminals;
subsequently receive a first report from the WLAN, the first report indicating that a first wireless terminal, covered by the subscription request, has connected to the WLAN; and
determine, based on the first report, to hold context information for the first wireless terminal, rather than releasing the context information.

56. The cellular network node of claim 55, wherein the request for the subscription includes one or more identifiers for wireless terminals or groups of wireless terminals, such that a given wireless terminal is covered by the subscription request only if it corresponds to at least one of the identifiers.

57. The cellular network node of claim 55, wherein the request for the subscription does not include any identifiers for wireless terminals or groups of wireless terminals, such that all wireless terminals are covered by the subscription request.

58. The cellular network node of claim 55, wherein the processing circuit is configured to send, to the WLAN, a message indicating that the subscription is to be terminated.

59. The cellular network node of claim 55, wherein the processing circuit is configured to add WLAN connection information to the context information, based on the first report.

60. The cellular network node of claim 55, wherein the processing circuit is configured to update performance management data, based on the first report.

61. The cellular network node of claim 55, wherein the processing circuit is configured to request, from the WLAN, further information regarding the first wireless terminal, in response to the first report.

62. The cellular network node of claim 55, wherein the processing circuit is configured to receive a second report from the WLAN, the second report indicating that the first wireless terminal has disconnected from the WLAN.

63. A wireless local-area network (WLAN) node, comprising:
a transceiver configured to send and receive wireless signals;
interface circuitry configured to enable communication to at least one node in a wide-area cellular network; and
a processing circuit configured to:
receive, from a first node in the wide-area cellular network, a request for a subscription to connection status information for one or more wireless terminals;
subsequently determine that a first wireless terminal covered by the subscription request has connected to the WLAN; and
send a first report to the wide-area cellular network, the first report indicating that the first wireless terminal has connected to the WLAN;
subsequently determine that the first wireless terminal covered by the subscription request has disconnected from the WLAN; and
send a second report to the wide-area cellular network, the second report indicating that the first wireless terminal has disconnected from the WLAN.

64. The WLAN node of claim 63, wherein the request for the subscription includes one or more identifiers for wireless terminals or groups of wireless terminals, such that a given wireless terminal is covered by the subscription request only if it corresponds to at least one of the identifiers.

65. The WLAN node of claim 63, wherein the request for the subscription does not include any identifiers for wireless terminals or groups of wireless terminals, such that all wireless terminals are covered by the subscription request.

66. The WLAN node of claim 63, wherein the processing circuit is configured to:
receive, from the wide-area cellular network, a message indicating that the subscription is to be terminated; and
refrain from sending further reports for wireless terminals covered by the subscription request.

67. A non-transitory computer-readable medium comprising, stored thereupon, program instructions that, when executed by a processor in a node in a wide-area cellular network, cause the node to:
send, to a first node in a wireless local-area network (WLAN) a request for a subscription to connection status information for one or more wireless terminals;
subsequently receive a first report from the WLAN, the first report indicating that a first wireless terminal, covered by the subscription request, has connected to the WLAN; and
determine, based on the first report, to hold context information for the first wireless terminal, rather than releasing the context information.

68. A non-transitory computer-readable medium comprising, stored thereupon, program instructions that, when executed by a processor in a node in a wireless local-area network (WLAN), causes the node to:
receive, from a first node in a wide-area cellular network, a request for a subscription to connection status information for one or more wireless terminals;
subsequently determine that a first wireless terminal covered by the subscription request has connected to the WLAN; and
send a first report to the wide-area cellular network, the first report indicating that the first wireless terminal has connected to the WLAN;
subsequently determine that the first wireless terminal covered by the subscription request has disconnected from the WLAN; and
send a second report to the wide-area cellular network, the second report indicating that the first wireless terminal has disconnected from the WLAN.
